(19) United States
(12) Patent Application Publication
(10) Pub. No.: US 2023/0173949 A1
(43) Pub. Date: Jun. 8, 2023

(54) MODULAR MULTI-TYPE POWER PACK CHARGING APPARATUS

(71) Applicant: SUSTAINABLE ENERGY TECHNOLOGIES, INC., Wilmington, DE (US)

(72) Inventor: John Cronin, Wilmington, DE (US)

(21) Appl. No.: 18/075,333

(22) Filed: Dec. 5, 2022

Related U.S. Application Data
(60) Provisional application No. 63/285,865, filed on Dec. 3, 2021.

(51) Int. Cl. B60L 58/18; H02J 7/00; H02J 7/34

(52) U.S. Cl. CPC B60L 58/18; H02J 7/0048; H02J 7/00032; H02J 7/00712; H02J 7/0013; H02J 7/345; B60L 53/60

(57) ABSTRACT

The present invention discloses a modular multi-type power pack charging apparatus. The modular multi-type power pack charging apparatus comprises a plurality of power packs coupled together in series or parallel and connected with charging hardware. A management database is provided and configured to store data related to a type of the plurality of power packs. A charging database is configured to store the charge cycle of each of the plurality of power packs for consumption. A processor with controller hardware and a memory unit coupled to the charging database and the management database to retrieve the performance of the plurality of power packs. The memory unit comprises a plurality of modules to perform charging and discharging of the plurality of power packs. Further, a display interface continuously displays a status of charging and/or discharging of the plurality of power packs.

### CROSS-REFERENCE TO RELATED APPLICATIONS

This application claims the benefit of U.S. Provisional Application No. 63/285,865, filed Dec. 3, 2021, for “A MODULAR MULTI-TYPE POWER PACK CHARGING APPARATUS,” the disclosure of which is incorporated herein by reference in its entirety.

### FIELD OF THE DISCLOSURE

The present disclosure is generally related to energy management and, more specifically, to energy management of power packs or batteries of different types.

### BACKGROUND

The subject matter discussed in the background section should not be assumed to be prior art merely due to its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Growth of electric vehicles (EVs) has evolved exponentially in recent years. For electric passenger cars intended for use on standard highways, two general classes of vehicle propulsion systems have evolved, i.e., pure electric vehicles and hybrid electric vehicles. Pure electric vehicles or vehicles having their propulsion provided only by an electric motor and on-board batteries have a battery management system to supply power to each of the vehicle's working components and maintain charging and discharging of individual battery units. Currently, battery management systems may obtain data about the individual battery units in a battery system. Such a system may require significant amounts of resources and complex arrangements for connecting the components of the system.

Further, battery management systems for lithium batteries, including those with multiple lithium batteries in series or in parallel, face special challenges. This is due in part to a non-linear discharge profile, with a relatively flat discharge region up to about 80% discharge. Therefore, a small change in voltage means a large difference in the state of charge, unlike a lead-acid battery with a relatively linear drop in voltage as the battery is discharged. The state of charge of a lead-acid battery, and therefore the amount of power remaining in a lead-acid battery, can be determined by simply monitoring the voltage of the lead-acid battery with a suitable data acquisition circuit and/or voltage detection circuit or other means. The amount of power remaining in a lithium battery system is more difficult to monitor and predict by simply measuring the voltage. Therefore, it would be more difficult to determine the available power remaining in a lithium battery unit by simply measuring the voltage.

As the cost to produce supercapacitors (SCAPs) or ultracapacitors continues to decline, they are carving out a niche in the marketplace between conventional capacitors and batteries. Supercapacitors are replacing lead-acid and lithium-based batteries in data storage applications requiring high current/short duration backup power. Furthermore, supercapacitors are also finding use in a variety of high peak power and portable applications in need of high current bursts or momentary battery backup. Compared to batteries, supercapacitors provide higher peak power bursts in smaller form factors and feature longer charge cycle life over a wider operating temperature range. Compared to standard ceramic, tantalum or electrolytic capacitors, supercapacitors offer higher energy density and higher capacitance in a similar form factor and weight. Moreover, supercapacitor lifetime is maximized by reducing the capacitor's top-off voltage and avoiding high temperatures (>50° C.). Supercapacitors are typically integrated into battery management systems.

Further, battery management systems may include a charging system configured to charge an individual battery pack to a predetermined voltage. However, the individual battery pack may not be charged to a maximum charge capacity level, and the discrepancy or uncertainty between the batteries' state of charge levels can cause the battery pack capacity to be limited. Therefore, the battery pack capacity is limited to the capacity of the lowest battery unit. Additionally, when some battery units have lower state-of-charge levels, as the battery discharges, those units may discharge to a level resulting in permanent loss of charging capacity. Further, the present battery control systems for rechargeable batteries that have over-charge and under-charge protection features typically utilize two relays or contacts that open to isolate the battery system in the event of an over-charge or under-charge condition. The two relays may be in series and require a manual reset and may use two relays in parallel, and each has a diode to control the flow of current to and from the battery. This system is complex and requires expensive components. Further, the energy consumption of each battery pack is continuous or excessive as the battery management system does not provide an optimized technique to utilize charge when required by the vehicle or when the path of the vehicle is steep or linear.

Unlike lead-acid or lithium-based batteries, supercapacitor batteries may have multiple sub modules within them that can be separately charged or discharged, as there may be multiple relays to address each sub module versus just two relays to create the flow of charge. This means that a battery management system for a supercapacitor and its sub modules will necessitate a unique approach.

Currently, electric vehicles employ a charging system through which batteries are charged by manually connecting an output port to an external power source, and the state of charge profile does not efficiently provide a complete profile about the maximum and minimum charging state of the batteries. Moreover, a common limitation related to currently available electric vehicles is a single battery charging apparatus. For instance, an electric vehicle operating on lithium batteries cannot charge lead-acid batteries and vice versa. Sometimes, there may be a need or desire with some electric vehicles to change the batteries, including the battery type, or to change the source of electric charge, and the battery management system may not be sufficiently flexible to be operable on different types of batteries with different charging and consumption cycles or different charging sources.

Therefore, there is a need for a multi-type battery charging apparatus for an electric vehicle to charge different types of batteries effectively and/or to efficiently manage the electric charge consumption from each battery pack. Usually, a fleet of vehicles that use EV may have various types of batteries, such as lithium, supercapacitors, lead-acid batteries, etc. Ideally, one battery management system should be able to seamless measure, test, and charge, in an optimum way each type of battery to which the battery management system connects. Such a battery management charging apparatus may solve one or more of the problems mentioned above but need not solve any or solve any one or more of these merely illustrative and non-comprehensive problems to be within the scope of the invention as claimed. The various problems mentioned above are not intended to be limiting regarding any aspect of the claimed invention.

### SUMMARY OF THE DISCLOSURE

According to one aspect, a modular multi-type power pack charging apparatus includes a plurality of power packs comprising at least two different types of power packs connected in series and/or in parallel, a processor communicatively coupled to the plurality of power packs to control charging and discharging of the plurality of power packs, and a memory unit communicatively coupled to the processor. In one embodiment, the memory unit includes a charging database to store information related to each type of power pack of the plurality of power packs and a plurality of energy source modules to control charging and discharging of a respective type of power pack according to instructions received from the processor. In one embodiment, the modular multi-type power pack charging apparatus further includes a display interface coupled to the processor and configured to continuously display a status of charging and discharging of the plurality of power packs.

In some embodiments, the at least two different types of power packs are selected from the group consisting of lithium, supercapacitor, and lead-acid. For example, in some embodiments, the plurality of power packs comprises a lithium power pack and a supercapacitor power pack. In other embodiments, the plurality of power packs comprises a lithium power pack and a lead-acid power pack.

The memory unit may further include an electrostatic module to determine the type of each power pack of the plurality of power packs, receive information related to the determined type of each power pack of the plurality of power packs from the charging database, determine a capacity of each power pack of the plurality of power packs from the received information, determine a charging state of each power pack of the plurality of power packs, determine that a first power pack of the plurality of power packs is charged below a first threshold limit based on the information retrieved from the charging database, and, in response to determining that the first power pack of the plurality of power packs is charged below the first threshold limit, instruct an energy source module corresponding to the type of the first power pack to charge the first power pack to the first threshold limit.

In one embodiment, the electrostatic module is further to determine that a second power pack of the plurality of power packs is charged below a second threshold limit and, in response to determining that the second power pack of the plurality of power packs is charged below the second threshold limit, instruct an energy source module corresponding to the type of the second power pack to charge the second power pack to the second threshold limit.

The memory unit may further include a dynamic module to determine whether a first power pack has a bidirectional charging capability and, in response to determining that the first power pack has a bidirectional charging capability, determine, while a first power pack is being charged, that electricity is flowing in a reverse direction from the first power pack to charging hardware for the first power pack, and, in response to determining, while the first power pack is being charged, that electricity is flowing in a reverse direction from the first power pack to the charging hardware, restricting electrical flow from the charging hardware to the first power pack.

In one embodiment, the dynamic module may, in response to determining that the first power pack does not have a bidirectional charging capability, report a real-time charging status of the first power pack.

The memory unit may further comprise an identifier module to identify charging and/or discharging requirements for each power pack of the plurality of power packs in order to meet power supply requirements of a particular device to be powered. The identifying module may further access information about the particular device to be powered, access information about each power pack of the plurality of power packs from the charging database, measure an amount of charge stored in each power pack of the plurality of power packs; determine if each power pack of the plurality of power packs has enough charge to meet the power supply requirements of the particular device; and, in response to determining that a first power pack of the plurality of power packs does not have enough charge to meet the power supply requirements of the particular device, charge the first power pack to a level to meet the power supply requirements of the particular device.

According to another aspect, a method includes providing a plurality of power packs comprising at least two different types of power packs connected in series and/or in parallel, communicatively coupling a processor to the plurality of power packs to control charging and discharging of the plurality of power packs, communicatively coupling a memory unit to the processor, the memory unit comprising a charging database to store information related to each type of power pack of the plurality of power packs and a plurality of energy source modules, each energy source module corresponding to a respective type of power pack, controlling charging and discharging of the plurality of power packs using the plurality of energy source modules according to instructions from the processor, and continuously displaying a status of charging and discharging of the plurality of power packs on a display interface.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one. In some examples, an element shown as an internal component of one element may be implemented as an external component in another and vice versa. Furthermore, elements may not be drawn to scale. Non-limiting and non-exhaustive descriptions are described regarding the following drawings. The components in the figures are not necessarily to scale, emphasis instead being placed upon illustrating principles.

FIG. 1A is a block diagram of an energy storage unit (ESU) and an energy control system (ECS), according to an embodiment.

FIG. 1B is a block diagram of a modular multi-type power pack charging apparatus, according to an embodiment.

FIG. 2 illustrates a charging database, according to an embodiment;

FIG. 3A and FIG. 3B illustrate a flowchart showing a method performed by a base module, according to an embodiment;

FIG. 4 illustrates a flowchart showing a method performed by an electrostatic module, according to an embodiment;

FIG. 5 illustrates a flowchart showing a method performed by a supercapacitor module, according to an embodiment;

FIG. 6 illustrates a flowchart showing a method performed by a lithium module, according to an embodiment;

FIG. 7 illustrates a flowchart showing a method performed by a lead-acid module, according to an embodiment;

FIG. 8 illustrates a flowchart showing a method performed by an identifier module, according to an embodiment;

FIG. 9 illustrates a flowchart showing a method performed by a charging module, according to an embodiment;

FIG. 10 illustrates a flowchart showing a method performed by a dynamic module, according to an embodiment; and

FIG. 11 illustrates a flowchart showing a method performed by a communication configuration module, according to an embodiment.

### DETAILED DESCRIPTION

Some embodiments of this disclosure, illustrating all its features, will now be discussed in detail. The words “comprising,” “having,” “containing,” and “including,” and other forms thereof are intended to be equivalent in meaning and be open-ended in that an item or items following any one of these words is not meant to be an exhaustive listing of such item or items or meant to be limited to only the listed item or items.

As used herein and in the appended claims, the singular forms “a,” “an,” and “the” include plural references unless the context clearly dictates otherwise. Although any systems and methods similar or equivalent to those described herein can be used to practice or test embodiments of the present disclosure, the preferred systems and methods are now described.

Embodiments of the present disclosure will be described more fully hereinafter with reference to the accompanying drawings in which like numerals represent like elements throughout the several figures and in which example embodiments are shown. However, embodiments of the claims may be embodied in many different forms and should not be construed as limited to the embodiments set forth herein. The examples set forth herein are non-limiting examples and are merely examples among other possible examples.

### Energy Storage Unit (ESU)

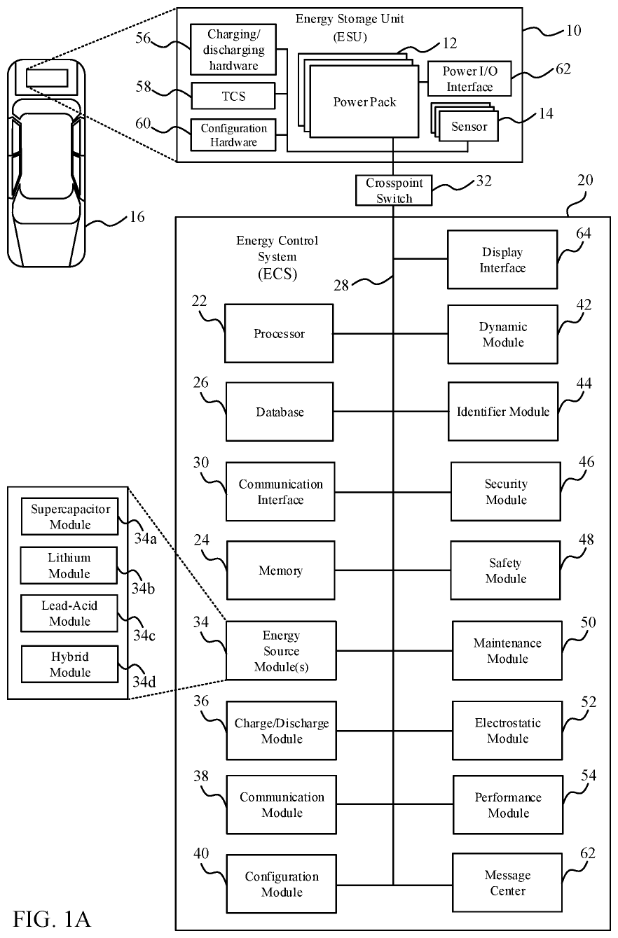

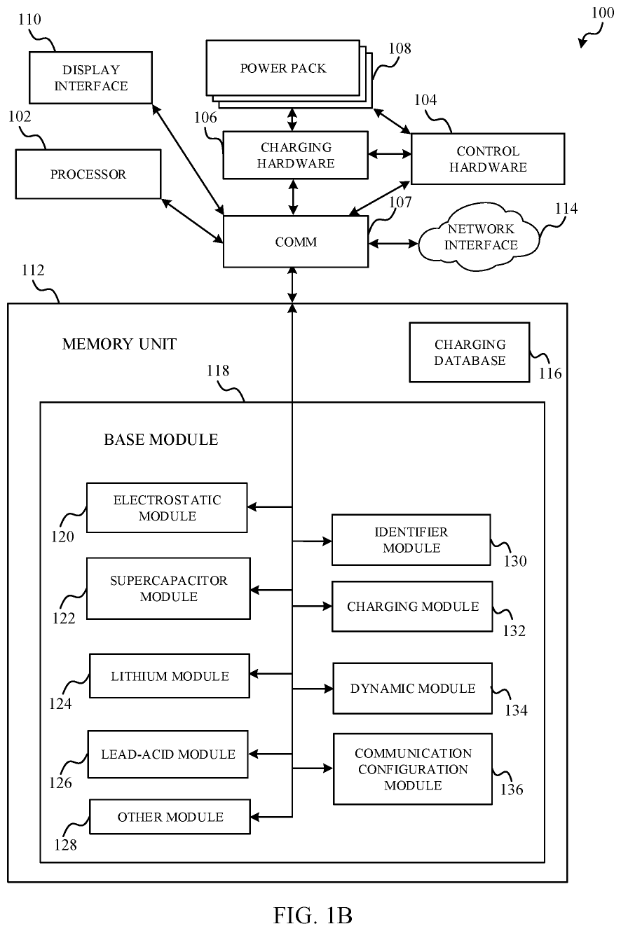

FIG. 1A illustrates an energy storage unit (ESU) 10 for supercapacitors according to one embodiment. As used herein, a supercapacitor may also be an ultracapacitor, which is an electrical component capable of holding hundreds of times more electrical charge than a standard capacitor. This characteristic makes ultracapacitors useful in devices that require relatively little current and low voltage. In some situations, an ultracapacitor can take the place of a rechargeable low-voltage electrochemical battery.

Ultracapacitors or supercapacitors typically have high power density meaning they can charge up quickly, but they also discharge quickly as well. The load curve of a chemical battery typically shows a high energy density, meaning that, on discharge, it is very stable (i.e., the voltage doesn't change much over time for a given load) for long periods of time. This means that the chemical battery (lead-acid or lithium-ion, etc.) has a high energy density but low power density. In other words, they charge slowly. Ultracapacitors or supercapacitors have been developed recently that have both a high power density (charge fast) and a high energy density (discharge slowly). Ideally, an ultracapacitor or supercapacitor has both a high power density and a high energy density, with a load discharge curve that resembles or comes close to a load discharge curve of a chemical battery. Hereafter, the term supercapacitor will be used generically to mean all forms of supercapacitors, but ideally one that has both high power density as well as high energy density.

The illustrated ESU 10 is a device that can store and deliver charge. It may comprise one or more power packs 12 which, in turn, may comprise supercapacitors. The ESU 10 may also comprise batteries, hybrid systems, fuel cells, etc. Capacitance provided in the components of the ESU 10 may be in the form of electrostatic capacitance, pseudocapacitance, electrolytic capacitance, electronic double layer capacitance, and electrochemical capacitance, and a combination thereof, such as both electrostatic double-layer capacitance and electrochemical pseudocapacitance, as may occur in supercapacitors. The ESU 10 may be associated with or comprise control hardware and software with suitable sensors 14, as needed, in order for an energy control system (ECS) 20 to manage any of the following: temperature control, discharging of the ESU 10 (whether collectively or of any of its components), charging of the ESU 10 (whether collectively or of any of its individual components), maintenance, interaction with batteries, battery emulation, communication with other devices, including devices that are directly connected, adjacent, or remote such as by wireless communication, etc. In some aspects, the ESU 10 may be portable and may be provided in a casing that also contains at least some components of the energy control system (ECS) 20 as well as various features, such as communication systems, a display interface, etc. The ESU 10 may be housed within, and provide power to, a device 16, such as an electric vehicle (EV).

### Energy Control System (ECS)

The ECS 20 is the combination of hardware and software that manages various aspects of the ESU 10 including the energy delivered by it to one or more devices. The ECS 20 regulates the ESU 10 to control discharging, charging, and other features as desired such as temperature, safety, efficiency, etc. The ESU 10 may be adapted to give the ECS 20 individual control over each power pack or optionally over each supercapacitor or grouped supercapacitor unit in order to efficiently tap the available power of individual supercapacitors and to properly charge individual supercapacitors rather than merely providing a single level of charge for the ESU 10 as a whole that may be too little or too much for individual supercapacitors or their power packs.

The ECS 20 may comprise or be operatively associated with a processor 22, a memory 24 comprising code for the controller, a database 26, a bus 28, and one or more communication interfaces 30, such as a wireless interface, for interacting with other units or otherwise providing information, information requests, or commands. The ECS 20 may interact with individual power packs 12 or supercapacitors through a crosspoint switch 32 or other matrix systems. Further, the ECS 20 may obtain information from individual power packs 12 or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack 12 or supercapacitor.

The ECS 20 may comprise one or more energy source modules 34, a charge/discharge module 36, a communication module 38, a configuration module 40, a dynamic module 42, an identifier module 44, a security module 46, a safety module 48, a maintenance module 50, an electrostatic module 52 and a performance module 54, etc. The ECS 20 may comprise one or more modules that can be executed or governed by the processor 22 according to code stored in a memory 24, such as a chip, a hard drive, a cloud-based source or other computer readable medium.

The ECS 20 may therefore manage any or all of the following: temperature control, discharging of the ESU 10 (whether collectively or of any of its components), charging of the ESU 10 (whether collectively or of any of its individual components), maintenance, interaction with batteries or battery emulation, and communication with other devices, including devices that are directly connected, adjacent, or remote, such as by wireless communication.

The ECS 20 may comprise one or more energy source modules 34 that govern specific types of energy storage devices, such as a supercapacitor module 34a for governing supercapacitors, a lithium module 34b for governing lithium batteries, a lead-acid module 34c for governing lead-acid batteries, and a hybrid module 34d for governing the combined cooperative use of a supercapacitor and a battery. Each of the energy storage modules 34 may comprise software encoding algorithms for control such as for discharge or charging or managing individual energy sources, and may comprise or be operationally associated with hardware for redistributing charge among the energy sources to improve efficiency of the ESU 10, for monitoring charge via charge measurement systems such as circuits for determining the charge state of the respective energy sources, etc., and may comprise or be operationally associated with devices for receiving and sending information to and from the ECS 20 or its other modules, etc. The energy source modules 34 may also cooperate with the charge/discharge module 36 responsible for guiding the charging of the overall ESU 10 to ensure a properly balanced charge, as well as the efficient discharging of the ESU 10 during use which may also seek to provide proper balance in the discharging of the energy sources.

The dynamic module 42 may be used for managing changing requirements in the power supplied. In some aspects, the dynamic module 42 comprises anticipatory algorithms which seek to predict upcoming changes in power demand and to adjust the state of the ECS 20 in order to be ready to more effectively handle the change. For example, in one case, the ECS 20 may communicate with a GPS and/or terrain map (not shown) for the route being taken by the electric vehicle and recognize that a steep hill will soon be encountered. The ECS 20 may anticipate the need to increase torque and thus deliver electrical power from the ESU 10, and thus activate additional power packs 12 if only some are in use or otherwise increase the draw from the power packs 12 in order to handle the change in slope efficiently to achieve desired objectives such as maintaining speed, reducing the need to shift gears on a hill, or reducing the risk of stalling or other problems.

The communication module 38 and an associated configuration system may be used to properly configure the ECS 20 to communicate not only with the interface or other aspects of a vehicle, but also to communicate with central systems or other vehicles, when desired. In such cases, a fleet of vehicles may be effectively monitored and managed to improve energy efficiency and track performance of vehicles and their ESUs 10, thereby providing information that may assist with maintenance protocols, for example. Such communication may occur wirelessly or through the cloud via the communication interface 30, and may share information with various central databases, or access information from databases to assist with the operation of the vehicle and the optimization of the ESU 10, for which historical data may be available in a database.

Databases 26 of use with the ECS 20 include databases 26 on the charge and discharge behavior of the energy sources in the ESU 10 in order to optimize both charging and discharging in use based on known characteristics, databases 26 of topographical and other information for a route to be taken by the electric vehicle or an operation to be performed by another device employing the ESU 10, wherein the database 26 provides guidance on what power demands are to be expected in advance in order to support anticipatory power management wherein the status of energy sources and the available charge is prepared in time to deliver the needed power proactively. Charging databases 26 may also be of use in describing the characteristics of an external power source that will be used to charge the ESU 10. Knowledge of the characteristics of the external charge can be used to prepare for impedance matching or other measures needed to handle a new input source to charge the ESU 10, and with that data the external power can be received with reduced losses and reduced risk of damaging elements in the ESU 10 by overcharge, excessive ripple in the current, etc.

Beyond relying on static information in databases 26, in some aspects, the processor 22 is adapted to perform machine learning and to constantly learn from situations faced. In related aspects, the processor and the associated software form a “smart” controller based on machine learning or artificial intelligence adapted to handle a wide range of input and a wide range of operational demands.

In one embodiment, the ESU 10 is governed or controlled by the ECS 20, which is adapted to optimize at least one of charging, discharging, temperature management, safety, security, maintenance, and anticipatory power delivery. The ECS 20 may communicate with a display interface 64, to assist in control or monitoring of the ESU 10 and also may comprise a processor and a memory. The ECS 20 may interact with the hardware of the ESU 10, such as charging and discharging hardware 56, a temperature control system (TCS) 58, and configuration hardware 60, which not only provide data to the ECS 20 but also respond to directions from the ECS 20 for the management of the ESU 10.

### ESU Hardware

### Charging and Discharging Hardware

The charging and discharging hardware 56 may include the wiring, switches, charge detection circuits, current detection circuits, and other devices for proper control of charge applied to the power packs 12 or to the batteries or other ESUs 10, as well as temperature-control devices, such as active cooling equipment and other safety devices. Active cooling devices (not shown) may include fans, circulating heat transfer fluids that pass through tubing or in some cases surround or immerse the power pack, and thermoelectric cooling, such as Peltier effect coolers, etc.

In order to charge and discharge an individual power pack 12 to optimize the overall efficiency of the ESU 10, methods and devices are provided to select one or more of many power packs 12 from what may be a three-dimensional or two-dimensional array of connectors to the individual units. Any suitable methods and devices may be used for such operations, including the use of crosspoint switches 32 or other matrix switching tools. Crosspoint switches 32 and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. Single-Pole Single-Throw (SPST) relays, for example, may be used. By applying charge to individual supercapacitors within power packs or to individual power packs within the ESU 10, charge can be applied directly to where it is needed and supercapacitor or power pack 12 can be charged to an optimum level independently of other power packs or supercapacitors. See “Understanding Tree and Crosspoint Matrix Architectures,” Pickering Test, https://www.pickeringtest.com/en-us/kb/hardware-topics/switching-architectures/understanding-tree-and-crosspoint-matrix-architectures, accessed Oct. 28, 2021.

Examples of crosspoint switches 32 and related components that may be adapted for one or more aspects of the disclosure herein, particularly the charging of supercapacitors or related power packs, are described in: “Digital Crosspoint Switches,” MicroSemi Corp. (Aliso Viejo, Calif.), https://www.microsemi.com/product-directory/signal-integrity/3579-digital-crosspoint-switches; “Micrel™ 2.5V/3.3V 3.0 GHz Dual 2×2 CML Crosspoint Switch w/Internal Termination, SuperLite™ SY55858U,” 2005, http://ww1.microchip.com/downloads/en/DeviceDoc/sy55858u.pdf; “Details, datasheet, quote on part number: BQ24640RVAR,” part of the BQ24640 family for “High Efficiency Synchronous Switch-Mode Battery Charge Controller for Supercapacitors,” Texas Instruments (Dallas, Tex.), https://www.digchip.com/datasheets/3258066-bq24640rvar.html; “8×8 Analog Crosspoint Switches Analog & Digital Crosspoint ICs,” Mouser Electronics (Mansfield, Tex.), https://www.mouser.com/c/semiconductors/communication-networking-ics/analog-digital-crosspoint-ics/; “200-MHz 16×16 Video Crosspoint Switch IC,” Analogue Dialogue, April 1997, https://www.analog.com/en/analog-dialogue/articles/200-mhz-16×16-video-crosspoint-switch-ic.html; “Crossbar Switch,” and Wikipedia, https://en.wikipedia.org/wiki/Crossbar_switch, accessed Oct. 28, 2021.

### Configuration Hardware

The configuration hardware 60 may include switches, wiring, and other devices to transform the electrical configuration of the power packs 12 between series and parallel configurations, such that a matrix of power packs may be configured to be in series, in parallel, or in some combination thereof. For example, as 12×6 array of power packs 12 may include four groups in series, with each group having 3×6 power packs in parallel. The configuration can be modified by a command from the configuration module 40, which then causes the configuration hardware 60 to make the change at an appropriate time (e.g., when the device is not in use).

### Sensors

The sensors 14 may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs 12 or batteries or other ESUs 10, or other characteristics of the ESU 10 or the device, as described more fully hereafter. The sensors 14 may comprise sensors physically contained in or on the ESU 10, or also comprise sensors mounted elsewhere such as engine gauges that are in electronic communication with the ESU 10 or its associated ECS 20.

### Batteries and Other Energy Sources

The ESU 10 may be capable of charging, or supplementing the power provided from the batteries or other ESUs 10 including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox-flow batteries, supercapacitor batteries, and combinations or hybrids thereof.

### Power Input/Output Interface

The ESU 10 also comprises or is associated with a power input/output interface 62 that can receive charge from a device (or a plurality of devices in some cases) such as the grid or from regenerative power sources in an electric vehicle (not shown), and can deliver charge to the device 16. The power input/output interface 62 may comprise one or more inverters, charge converters, or other circuits and devices to convert the current to the proper type (e.g., AC or DC) and voltage or amperage for either supplying power to, or receiving power from, the device to which it is connected. Bidirectional DC-DC converters may also be applied, as described in the case of electric vehicles in M. B. Camara et al., “Polynomial Control Method of DC/DC Converters for DC-Bus Voltage and Currents Management—Battery and Supercapacitors,” IEEE Transactions on Power Electronics, vol. 27, no. 3 (March 2012): 1455-67, DOI: 10.1109/TPEL.2011.2164581.

The power input/output interface 62 may be adapted to receive power from a wide range of power sources, such as via two-phase or three-phase power, DC power, etc., and may receive or provide power by wires or inductively or any other useful means. Converters, transformers, rectifiers, and the like may be employed as needed. The power received may be relatively steady from the grid or other sources at voltages such as 110V, 120V, 220V, 240V, etc., or may be from highly variable sources such as from solar or wind power where amperage or voltage may vary. DC sources may be, by way of example, from 1V to 1000V or higher, such as from 4V to 200V, 5V to 120V, 6V to 100V, 2V to 50V, 3V to 24V, or nominal voltages of about 4, 6, 12, 18, 24, 30, or 48 V. Similar ranges may apply to AC sources, but also including from 60V to 300V, from 90V to 250V, from 100V to 240 V, etc., operating at any useful frequency such as 50 Hz, 60 Hz, 100 Hz, etc.

Power received or delivered may be modulated, converted, smoothed, rectified, or transformed in any useful way to better meet the needs of the application and the requirements of the device and/or the ESU 10. The use of impedance matchers, for example, can help optimize the transfer of power from a photovoltaic array to a DC or AC source such as a powered device or the grid. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient transfer of power.

The power input/out interface 62 may have a plurality of receptacles for receiving power and a plurality of outlets for providing power to one or more devices. Conventional AC outlets may include any known outlet such as those common in North America, various parts of Europe, China, Hong Kong, etc.

### ECS Components and Modules

### Processor

The processor 22 may comprise one or more microchips or other systems for executing electronic instructions and can provide instructions to regulate the charging and discharging hardware 56 and, when applicable, the configuration hardware 60 or other aspects of the ESU 10 and/or other aspects of the ECS 20 and its interactions with the device, the cloud, etc. In some cases a plurality of processors 22 may collaborate, including processors 22 installed with the ESU 10 and processors installed in a vehicle or other device.

### Memory

The memory 24 may comprise coding for operation of one or more of the ECS 20 modules and their interactions with each other or other components. It may also comprise information, such as databases pertaining to any aspect of the operation of the ECS 20. Additional databases 26 may be stored in a storage device, such as a hard disk drive, or may be available via the cloud. Such databases 26 can include a charging database that describes the charging and/or discharging characteristics of a plurality or all of the energy sources (the power packs and the batteries or other energy storage units), for guiding charging and discharging operations. Such data may also be included with energy-source-specific data provided by or accessed by the energy source modules 34.

The memory 24 may be in one or more locations or components, such as a memory chip, a hard drive, a cloud-based source or other computer readable medium, and may be in any useful form such as flash memory, EPROM, EEPROM, PROM, MROM, etc., or combinations thereof and in consolidated (centralized) or distributed forms. The memory 24 may in whole or in part be read-only memory (ROM) or random-access memory (RAM), including static RAM (SRAM), dynamic RAM (DRAM), synchronous dynamic RAM (SDRAM), and magneto-resistive RAM (MRAM), etc.

The ECS 20 may communicate with other entities via the cloud or other means, and such communication may involve information received from and/or provided to one or more databases 26 and a message center 62. The message center 62 can be used to provide alerts to an administrator responsible for the ESU 10 and/or the electric vehicle or other device. For example, an entity may own a fleet of electric vehicles using ESUs 10, and may wish to receive notifications regarding usage, performance, maintenance issues, and so forth. The message center 62 may also participate in authenticating the ESU 10 or verifying its authorization for use in the electric vehicle or other device via interaction with the security module 46.

### Energy Source Modules

The energy source modules 34 may comprise specific modules designed for the operation of a specific type of energy source such as supercapacitor module 34a, a lithium battery module 34b, a lead-acid battery module 34c, a hybrid module 34d, or other modules. Such modules may be associated with a database 26 of performance characteristics (e.g., charge and discharge curves, safety restrictions regarding overcharge, temperature, etc.) that may provide information for use by the safety module 48 and the charge/discharge module 36, which is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

### Charge/Discharge Module

The charge/discharge module 36 is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring during charging that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

The charge/discharge module 36 may be configured to charge or discharge each of the plurality of power packs 12 up to a threshold limit. The charge/discharge module 36 may be communicatively coupled to the performance module 54, the energy source modules 34, and the identifier module 44, among others, and may communicate with the charging/discharging hardware 56 of the ESU 10. For example, in one aspect, the threshold limit may be more than 90 percent capacity of each of the plurality of power packs 12.

### Dynamic Module

The dynamic module 42 assists in coping with changes in operation including acceleration, deceleration, stops, changes in slopes (uphill or downhill), changes in traction or properties of the road or ground that affect traction and performance, etc., by optimizing the delivery of power or the charging that is taking place for individual power packs 12 or batteries or other ESUs 10. In addition to guiding the degree of power provided by or to individual power packs 12 based on current use of the device 16 and the individual state of the power packs 12, in some aspects the dynamic module 42 provides anticipatory management of the ESU 10 by proactively adjusting the charging or discharging states of the power packs 12 such that added power is available as the need arises or slightly in advance (depending on time constants for the ESU 10 and its components, anticipatory changes in status may only be needed for a few seconds (e.g., 5 seconds or less or 2 seconds or less) or perhaps only for 1 second or less such as for 0.5 seconds or less, but longer times of preparatory changes may be needed in other cases, such as from 3 seconds to 10 seconds, to ensure that adequate power is available when needed but that power is not wasted by changing the power delivery state prematurely. This anticipatory control can involve not only increasing the current or voltage being delivered, but also increasing the cooling provided by the cooling hardware of the charging and discharging hardware 56 in cooperation with safety module 48 and when suitable with the charge/discharge module 36.

The dynamic module 42 may be communicatively coupled to the charge/discharge module 36. The dynamic module 42 may be configured to determine the charging and discharging status of the plurality of power packs 12 and batteries or other ESUs 10 in real-time. For example, in one aspect, the dynamic module 42 may help govern bidirectional charge/discharge in real-time in which the electric charge may flow from the ESU 10 into the plurality of power packs 12 and/or batteries or other ESUs 10 or vice versa.

### Configuration Module

The ECS 20 may comprise a configuration module 40 configured to determine any change in configuration of charged power packs 12 from the charging module. For example, in one aspect, the configuration module 40 may be provided to change the configuration of the power packs 12, such as from series to parallel or vice versa. This may occur via communication with the charging/discharging hardware 56 of the ESU 10.

### Identifier Module

The identifier module 44, described in more detail hereafter, identifies the charging or discharging requirement for each power pack 12 to assist in best meeting the power supply needs of the device 16. This process may require access to database information about the individual power packs 12 from the energy source modules 34 (e.g., a supercapacitor module 34a) and information about the current state of the individual power packs 12 provided by the sensors 14 and charge and current detections circuits associated with the charging and discharging hardware 56, cooperating with the charge/discharge module 36 and, as needed, with the dynamic module 42 and the safety module 48.

### Safety Module

The sensors 14 may communicate with the safety module 48 to determine if the temperature of the power packs 12 and/or individual components therein show signs of excessive local or system temperature that might harm the components. In such cases, the safety module 48 interacts with the processor 22 and other features (e.g., data stored in the databases 26 of the cloud or in memory 24 pertaining to safe temperature characteristics for the ESU 10) to cause a change in operation such as decreasing the charging or discharging underway with the portions of the power packs 12 or other units facing excessive temperature. The safety module 48 may also regulate cooling systems that are part of the charging and discharging hardware 56 in order to proactively increase cooling of the power packs 12 or batteries or other ESUs 10, such that increasing the load on them does not lead to harmful temperature increase.

Thus, the safety module 48 may also interact with the dynamic module 42 in responding to forecasts of system demands in the near future for anticipatory control of the ESU 10 for optimized power delivery. In the interaction with the dynamic module 42, the safety module 48 may determine that an upcoming episode of high system demand from the device 16, such as imminent climbing of a hill, may impose excessive demands on a power pack already operating at elevated temperature, and thus make a proactive recommendation to increase cooling on the at-risk power packs 12. Other sensors 14, such as strain gauges, pressure gauges, chemical sensors, etc., may be provided to determine if any of the ESUs 10 in batteries or other ESUs 10 or the power packs 12 are facing pressure buildup from outgassing, decomposition, corrosion, electrical shorts, unwanted chemical reactions such as an incipient runaway reaction, or other system difficulties. In such cases, the safety module 48 may then initiate precautionary or emergency procedures such as a shut down, electrical isolation of the affected components, warnings to a system administrator via the communication module 38 to the message center 62, a request for maintenance to the maintenance module 50.

### Maintenance Module

The maintenance module 50 determines when the ESU 10 requires maintenance, either per a predetermined schedule or when needed due to apparent problems in performance, as may be flagged by the performance module 54, or in issues pertaining to safety as determined by the safety module 48 based on data from sensors 14 or the charging/discharging hardware 56, and in light of information from the energy sources modules 34. The maintenance module 50 may cooperate with the communication module 38 to provide relevant information to the display interface 64 and/or to the message center 62, where an administrator or owner may initiate maintenance action in response to the message provided. The maintenance module 50 may also initiate mitigating actions to be taken such as cooperating with the charge/discharge module 36 to decrease the demand on one or more of the power packs 12 in need of maintenance, and may also cooperate with the configuration module 40 to reconfigure the power packs 12 to reduce the demand in components that may be malfunctioning of near to malfunctioning to reduce harm and risk.

### Performance Module

The performance module 54 continually monitors the results obtained with individual power packs 12 and the batteries or other ESUs 10 and stores information as needed in memory 24 and/or in the databases 26 of the cloud or via messages to the message center 62. The monitoring is done through the use of the sensors 14 and the charging/discharging hardware 56, etc. The tracking of performance attributes of the individual energy sources can guide knowledge about the health of the system, the capabilities of the components, etc., which can guide decisions about charging and discharging in cooperation with the charge/discharge module 36. The performance module 54 compares actual performance, such as power density, charge density, time to charge, thermal behavior, etc., to specifications and can then cooperate with the maintenance module 50 to help determine if maintenance or replacement is needed and alert an administrator via the communication module 38 with a message to the message center 62 about apparent problems in product quality.

### Security Module

The security module 46 helps to reduce the risk of counterfeit products or of theft or misuse of legitimate products associated with the ESU 10, and thus can include one or more methods for authenticating the nature of the ESU 10 and/or authorization to use it with the device 16 in question. Methods of reducing the risk of theft of unauthorized use of an ESU 10 or its respective power packs 12 can include locks integrated with the casing of the ESU 10 that mechanically secure the ESU 10 in the electric vehicle or other device 16, wherein a key, a unique fob, a biometric signal such as a finger print or voice recognition system, or other security-related credentials may be required to enable removal of the ESU 10 or even operation thereof.

In another aspect, the ESU 10 comprises a unique identifier (not shown) that can be tracked, allowing a security system to verify that a given ESU 10 is authorized for use with the device 16, such as an electric vehicle. For example, the casing of the ESU 10 or of one or more power packs 12 therein may have a unique identifier attached such as an RFID tag with a serial number (an active or passive tag), a holographic tag with unique characteristics equivalent to a serial number or password, nanoparticle markings that convey a unique signal, etc. One exemplary security tool that may be adapted for the security of the ESU 10 is a seemingly ordinary bar code or QR code with unique characteristics not visible to the human eye that cannot be readily copied, is the Unisecure™ technology offered by Systech (Princeton, N.J.), a subsidiary of Markem-Image, that essentially allows ordinary QR codes and barcodes to become unique, individual codes by analysis of tiny imperfections in the printing to uniquely and robustly identify every individual products, even if it seems that the same code is printed on each product. The technology is described in part in U.S. Pat. No. 10,380,601, “Method and system for determining whether a mark is genuine,” issued Aug. 13, 2019 to M. L. Soborski; U.S. Pat. No. 9,940,572, “Methods and a computing device for determining whether a mark is genuine,” issued Apr. 10, 2018 to M. L. Soborski; U.S. patent Ser. No. 10/235,597, “Methods and a computing device for determining whether a mark is genuine,” issued Mar. 19, 2019 to M. Voigt et al.; U.S. Pat. No. 9,519,942, “Methods and a computing device for determining whether a mark is genuine,” issued Dec. 13, 2016 to M. L. Soborski; and U.S. Pat. No. 8,950,662, “Unique identification information from marked features,” issued Feb. 10, 2015 to M. L. Soborski.

Yet another approach relies at least in part in the unique electronic signature of the ESU 10, and/or of one or more individual power packs 12 or of one or more supercapacitor units therein. The principle will be described relative to an individual power pack 12, but may be adapted to an individual supercapacitor or collectively to the ESU 10 as a whole. When a power pack 12 comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack 12 may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements. etc. An electronic signature of time effects (characteristic changes in time of voltage or current, for example, is response to an applied load of some kind) may be explored for a specified scenario such as charging a 90% discharged power pack to a state of 50% charge or examining the response to difference applied voltages such as −3V to +4V. Voltammograms may be obtained showing, for example, the response of the power pack to different scan rates. See, for example, “Testing Super-Capacitors, Part 1: CV, EIS, and Leakage Current,” Apr. 16, 2015, https://www.gamry.com/assets/Uploads/Super-capacitors-part-1-rev-2.pdf, and “Testing Electrochemical Capacitors Part 2—Cyclic Charge Discharge and Stacks,” Nov. 14, 2011, https://www.gamry.com/assets/Application-Notes/Testing-Super-Capacitors-Pt2.pdf. Instrumentation for such testing may include a variety of electrical signal analysis tools, including, for example, the Gamry Instruments PWR800 system (Gamry Instruments Inc., Warminster, Pa.). Also see Erik Surewaard et al., “A Comparison of Different Methods for Battery and Supercapacitor Modeling,” SAE Transactions, Journal of Engines, vol. 112, Section 3 (2003): 1851-1859, https://www.jstor.org/stable/44741399. Also see Yuru Ge et al., “How to measure and report the capacity of electrochemical double layers, supercapacitors, and their electrode materials,” Journal of Solid State Electrochemistry, vol. 24 (2020): 3215-3230, https://link.springer.com/article/10.1007/s10008-020-04804-x.

Recognizing that the details of supercapacitor response to a certain load or charge/discharge process may vary gradually over time, especially if the supercapacitor has been exposed to excess voltage or other mechanical or electrical stress, the security module 46 can be adaptive and recognize and accept change within certain limits. Changes observed in the response characteristics can be used to update a security database or performance database for the ESU 10, so that future authentication operations will compare the measured behavior profile of the ESU's power pack in question with the updated profile for authentication purposes and for tracking of performance changes over time. Such information may also be shared with the maintenance module 50 (and may be stored in the database 26), which may trigger a request or requirement for service if there are indications of damage pointing to the need of repair or replacement. When a power pack 12 or supercapacitor therein is replaced due to damage, the response profile of the power pack 12 can then be updated in the security database. When such physical changes cause changes to the measured electronic characteristics that exceed a reasonable threshold, the authorization for use of that ESU 10 may be withdrawn pending further confirmation of authenticity or necessary maintenance.

In another aspect, each ESU 10 and optionally each power pack 12 of the ESU 10 may be associated with a unique identifier registered in a blockchain system, and each “transaction” of the ESU 10, such as each removal from a vehicle, maintenance operations, purchase or change in ownership, and installation into a vehicle or other device, can be recorded and tracked. A code, e.g., Radio Frequency Identification (RFID) signal, or other identifier may be read or scanned for each transaction, such that the blockchain record may then be updated. The blockchain record may comprise an information about the authorization state of the product, such as information on what vehicle or vehicles or products the ESU 10 is authorized for, or an identifier associated with the authorized user may be provided which can be verified or authenticated when the ESU 10 is installed in a new setting or when a transaction occurs. The authorization record may be updated at any time, including when a transaction occurs. Mechanisms may be provided by the vendor to resolve disputes regarding authorization status or other questions.

In some aspects, such as in military or government operation, the ESU 10 may comprise an internal “kill switch” or other inactivation device (not shown) that can be remotely activated by authorities in the event of a crime, unauthorized use, or violation of contract. Alternatively, or in addition, an electric vehicle or other device may be adapted to reject installation of an ESU 10 that is not authorized for use in the vehicle or device 16.

### Communication Module

The communication module 38 can govern communications between the ECS 20 and the outside world, including communications through the cloud, such as making queries and receiving data from various external databases or sending messages to a message center where they may be processed and archived by an administrator, a device owner, the device user, the ESU 10 owner, or automated systems. In some aspects, the communication module 38 may also oversee communication between modules or between the ESU 10 and the ECS 20, and/or work in cooperation with various modules to direct information to and from the display interface 64. Communications within a vehicle or between the ECS 20 or ESU 10 and the device may involve a DC bus 28 or other means such as separate wiring. Any suitable protocol may be used, including UART, LIN (or DC-LIN), CAN, SPI, I2C (including Intel's SMBus), and DMX (e.g., DMX512). In general, communications from the ECS 20 or ESU 10 with a device may be over a DC bus 28 or, if needed, over an AC/DC bus, or by separately wired pathways if desired, or may be wireless. Useful transceivers for communicating over DC lines include, for example, the SIG family and DCB family of transceivers from Yamar Electronics, LTD (Tel Aviv, Israel), and Yamar's DCAN500 device for CAN2.0 AB protocol messages.

Communication to the cloud may occur via the communication module 38 and may involve a wired or a wireless connection. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an ESU 10 can be conducted based on measurements made with the charging/discharging hardware 56, in communication with certain modules of the ECS 20. In general, the measurement of charge and processing of the data can be said to be managed by an electrostatic module.

The electrostatic module 52 may be configured to identify the power pack type and the capacity of each power pack connected to the modular multi-type power pack ESU 10. Further, the electrostatic module may be configured to retrieve information related to the type of power packs 12 from the charging database 26. The electrostatic module 52 may determine the capacity of each power pack to be charged and may be configured to determine the capacity of each power pack when connected to the modular multi-type power pack ESU 10.

The electrostatic module may be configured to determine if each power pack charged below the threshold limit. For example, in one aspect, the electrostatic module 52 may check whether each of the plurality of power packs 12 may have capacity below the threshold limit. The electrostatic module 52 may also be configured to send data related to power packs 12 to the ECS 20.

### Various Databases

The ECS 20 may access various databases 26 locally or via an interface to the cloud and store retrieved information in the memory 24 for use to guide the various modules.

Further, the memory 24 may comprise a charging database 26 or information from such a database obtained from the databases 26 located in the cloud or otherwise. In one aspect, the charging database 26 may be configured to store information related to various power packs 12 used while charging and discharging from the ESU 10. In one aspect, the charging database 26 may be configured to store information related to the power cycle of each of the plurality of power packs 12, the maximum and minimum charge for different types of power packs 12, and the state of charge (SoC) profile of each of the plurality of power packs 12.

The charging database 26 may be configured to store information related to the management of the plurality of power packs 12, such as the type of power pack to be charged, safety specifications, recent performance data, bidirectional charging requirements or history of each of the plurality of power packs 12, etc. In another aspect, the stored information may also include, but is not limited to, the capacity of each of the plurality of power packs 12, amount of charge required for one trip of the device 16 along the path, such as golf course, etc., charging required for a supercapacitor unit, etc. In another aspect, the charging database 26 may provide a detailed research report for the device's average electric charge consumption over a path. In one aspect, the charging database 26 may be configured to store information of the consumption of the electric charge per unit per kilometer drive of the device 16 from the plurality of power packs 12. For example, such information may indicate that a golf cart is equipped with 5 supercapacitor-driven power packs 12 each at 90% charge, with each power pack able to supply a specified amount of ampere hours (Ah) of electric charge resulting in an ability to drive under normal conditions at top speed for, e.g., 80 kilometers. The information may also indicate that a solar cell installed on the roof of the golf cart would, under current partly clouded conditions, still provide enough additional charge over the planned period of use to extend the capacity of the ESU 10 by another 40 kilometers for 1 passenger.

The charging database 26 may be used by the performance module 54 for both reading data and storing new data on the individual energy storage units 10, such as the power packs 12.

### Power Pack

The power pack 12 is a unit that can store and deliver charge within an ESU 10 and comprises one or more supercapacitors such as supercapacitors in series and/or parallel. It may further comprise or cooperate with sensors 14, e.g., temperature sensors, charge and current sensors (circuits or other devices), connectors, switches such as crosspoint switches 32, safety devices, and control systems, such as charge and discharge control systems. In various aspects described herein, the power pack 12 may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack 12 may have a functional temperature range from −70° C. to 150° C., such as from −50° C. to 100° C. or from −40° C. to 80° C. The voltage provided by the power pack may be any practical value such as 3V or greater, such as from 3V to 240 V, 4V to 120 V, etc.

By way of example, a power pack 12 may comprise one or more units each comprising at least one supercapacitor having a nominal voltage from 2 to 12 V such as from 3 to 6 V, including supercapacitors rated at about 3, 3.5, 4, 4.2, 4.5, and 5 V. For example, a power pack 12 may be provided with 14 capacitors in series and five series in parallel and charged with 21,000 F at 4.2 V to provide 68-75 Wh. Power packs 12 may be packaged in protective casings that allow them to be easily removed from an ESU 10 and replaced. They may also comprise connectors for charging and discharging. Power packs 12 may be provided with generally rectilinear casings or they may have cylindrical or other useful shapes.

### Supercapacitors

Principles for the design, manufacture, and operation of supercapacitors included in one or more power packs 12 are described, by way of example, in U.S. Pub. No. 2019/0180949, “Supercapacitor,” published Aug. 29, 2017 by Liu Sizhi et al. and PCT Pub. No. WO2018041095, “Supercapacitor,” published Mar. 8, 2018 by Liu Sizhi et al.; U.S. Pat. No. 9,318,271, “High temperature supercapacitor,” issued Apr. 19, 2016 to S. Fletcher et al.; US20150047844, “Downhole supercapacitor device”; U.S. Pub. No. 2020/0365336, “Energy storage device Supercapacitor and method for making the same”; U.S. Pat. No. 9,233,860, “Supercapacitor and method for making the same”; and U.S. Pat. No. 9,053,870, “Supercapacitor with a meso-porous nano graphene electrode.” Also see Chinese Pat. No. CN 106252099B, “Supercapacitor” by Liu Sizhi et al., published Apr. 10, 2018; Chinese Pat. No. CN 106252096B, “Supercapacitor” by Liu Sizhi et al., published Jan. 23, 2018; and Chinese Pat. No. CN 104057901B, “Automobile Power-supply Management System with Supercapacitor” by Yang Weiming et al., published Apr. 27, 2016.

A supercapacitor may have two electrode layers separated by an electrode separator wherein each electrode layer is electrically connected to a current collector supported upon an inert substrate layer, an electrolyte-impervious layer disposed between each electrode layer and each conducting layer to protect the conducting layer, and a liquid electrolyte disposed within the area occupied by the working electrode layers and the electrode separator. The liquid electrolyte may be an ionic liquid electrolyte gelled by a silica gellant or other gellant to inhibit electrolyte flow.

The supercapacitor may comprise an electrode plate, an isolation film, a pole, and a shell, wherein the electrode plate comprises a current collector and a coating is disposed on the current collector. The coating may comprise an active material that may include carbon nanomaterial, such as graphene or carbon nanotubes, including nitrogen-doped graphene, a carbon nitride, carbon materials doped with a sulfur compound, such as thiophene or poly 3-hexylthiophene etc., or graphene on which is deposited nanoparticles of metal oxide such as manganese dioxide. The coating may further comprise a conductive polymer, such as one or more of polyaniline, polythiophene and polypyrrole. Such polymers may be doped with a variety of substances including boron (especially in the case of polyaniline). Nitrogen doping, for example, is described more fully by Tianquan Lin et al, “Nitrogen-doped mesoporous carbon of extraordinary capacitance for electrochemicalenergy storage,” Science (new series), vol. 350, no. 6267 (18 Dec. 2015): 1508-1513, https://www.jstor.org/stable/24741499.

Electrodes in supercapacitors may have thin coatings in electrical communication with a current collector. To provide high electrode surface area for high performance, electrodes may comprise porous material with high specific surface area such as graphene, graphene oxide, or various derivatives of graphene, carbon nanotubes or other carbon nanomaterials including activated carbon, nitrogen doped graphene or other doped graphene, graphite, carbon fiber-cloth, carbide-derived carbon, carbon aerogel, and/or may comprise various metal oxides such as oxides of manganese, etc., and all such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors 14 pertaining to charge state, temperature, and other aspects of performance and safety. An actuation mechanism may be integrated to prevent undesired discharge.

The voltage of an individual supercapacitor may be greater than 2 V such as from 2.5 V to 5 V, 2.7 V to 8 V, 2.5 V to 4.5 V, etc.

### Powered Devices

Powered devices 16 that may be powered by the ESU 10 can include electric vehicles and other transportation devices of all kinds, such as those for land, water, or air, whether adapted to operate without passengers or with one or more passengers. Electric vehicles may include, without limitation, automobiles, trucks, vans, fork lifts, carts, such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like. The electric vehicle generally comprises one or more motors connected to the ESU 10 and ECS 20 that controls the power delivered from the ESU 10, and may comprise a user interface that provides information and/or control regarding the delivery of power from the ESU 10 as well as information regarding performance, remaining charge, safety, maintenance, security, etc. Not all transportation devices require non-stationary motors. An elevator, for example, may have a substantially stationary motor while the cabin moves between level of a structure. Other transport systems with mobile cabins, seats, or walkways may be driven by stationary motors driving cables, chains, gears, bands, etc.

Principles for the manufacture and design of electric vehicles and aspects of their charging are provided in U.S. Pub. No. 2019/0061541, “Electric vehicle batteries and stations for charging batteries”; European Pat. No. EP2278677B, “Safety Switch for Secondary Battery for Electric Vehicle and Charging/Discharging System for Secondary Battery for Electric Vehicle Using the Same”; U.S. Pub. No. 2019/0061541, “Electric vehicle batteries and stations for charging batteries,” etc. The relationship between the ESU 10 and the drive train, especially when individual control of wheel speed is provided, can be optimized with neural network systems for traction control and efficiency. See Abdelhakim Haddoun, “Modeling, Analysis, and Neural Network Control of an EV Electrical Differential,” IEEE TRANSACTIONS ON INDUSTRIAL ELECTRONICS, vol. 55, no. 6 (June 2008): 2286-94, https://www.researchgate.net/publication/3219993.

Apart from electric vehicles, there are many other devices 16 that may be powered by the ESU 10 in cooperation with the ECS 20. Such other devices can include generators, which in turn can power an endless list of electric devices in households and industry. ESUs 10 of various size and shape can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the device being powered is the grid, and in such versions, the ESU 10 may comprise an inverter to turn DC current into AC current suitable for the grid.

In some aspects, a plurality of devices 16, such as electric vehicles, may be networked together via a cloud-based network, wherein the devices 16 share information among themselves and/or with a central message center 62 such that an administrator can assist in managing the allocation of resources, oversee maintenance, evaluate performance of vehicles and ESUs 10, upgrade software or firmware associated with the ECS 20 to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU 10 may comprise both power packs 12, as well as one or more lead-acid batteries or other batteries. The ESU 10 may power both the motor as well as the on-board power supply system.

### Motors

Any kind of electric motor may be powered by the ESU 10. The major classes of electric motors are: 1) DC motors, such as series, shunt, compound wound, separately excited (wherein the connection of stator and rotor is done using a different power supply for each), brushless, and PMDC (permanent magnet DC) motors, 2) AC motors, such as synchronous, asynchronous, and induction motors (sometimes also called asynchronous motors), and 3) special purpose motors, such as servo, stepper, linear induction, hysteresis, universal (a series-wound electric motor that can operate on AC and DC power), and reluctance motors.

### Display Interface

The display interface 64 of the ECS 20 may be displayed on or in the device 16, such as on a touch screen or other display in a vehicle or on the device 16, or it may be displayed by a separate device, such as the user's phone. The display interface 64 may comprise or be part of a graphic user interface such the control panel (e.g., a touch panel) of the device 16. The display interface may also comprise audio information and verbal input from a user. It may also be displayed on the ESU 10 itself or on a surface connected to or in communication with the ESU 10. In one version, the display interface 64 may include, but is not limited to, a video monitoring display, a smartphone, a tablet, and the like, each capable of displaying a variety of parameters and interactive controls, but the display interface 64 could also be as simple as one or more lights indicating charging or discharging status and optionally one or more digital or analog indicators showing remaining useful lifetime, % power remaining, voltage, etc. Further, the display interface 64 may be any state-of-the-art display means without departing from the scope of the disclosure. In some aspects, the display interface 64 provides graphical information on charge status, including one or more of fraction of charge remaining or consumed, remaining useful life of the ESU 10 or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU 10 for shipping, discharge the ESU 10, increase active cooling, only apply low power, etc.); planned conditions for use (e.g., outdoors, high-humidity, in rain, underwater, indoors, etc.). Selections may be made through menus and/or buttons on a visual display, through audio presentation of information responsive to verbal commands, or through text commands or displays transmitted to a phone or computer, including text messages or visual display via an app or web page.

Thus, the ESU 10 may comprise a display interface 64 coupled to the processor 22 to continuously display the status of charging and discharging the plurality of power packs 12.

### Solar Power and Alternative Energy Systems

The ESU 10 may receive energy from solar panels coupled through one or more solar regulators and/or inverters. Solar panels produce electrical power through the photovoltaic effect, converting sunlight into DC electricity. This DC electricity may be fed to a battery via a solar regulator to ensure proper charging and prevent damage to the power pack 12. While DC devices can be powered directly from the battery or the regulator, AC devices require an inverter to convert the DC electricity to suitable AC current at, for example, 110V, 120V, 220V, 240V, etc.

Solar panels may be wired in series or in parallel to increase voltage or current, respectively. The rated terminal voltage of, e.g., a 12 Volt solar panel may actually be around 17 Volts, but the regulator may reduce the voltage to a lower level required for battery charging.

### Solar Regulators

Solar regulators (also called charge controllers) regulate current from the solar panels to prevent battery overcharging, reducing, or stopping current as needed. They may also include a Low Voltage Disconnect feature to switch off the supply to the load when battery voltage falls below the cut-off voltage and may also prevent the battery sending charge back to the solar panel in the dark.

Regulators may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current voltage like a conventional step-down DC-DC converter, but adding the “smart” aspect of monitoring of the variable maximum power point of the panel to adjust the input voltage of the DC-DC converter to deliver optimum power.

### Inverters

Inverters are devices that convert the DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage but are more complex and costly that on-grid systems, requiring additional equipment. An inverter/charger that manages both grid connection and the charging or discharging of batteries may be called interactive or multi-mode inverters. A variation of such inverters is known as the all-in-one hybrid inverter.

Output from inverters may be in the form of a pure sine wave or a modified sine wave or square wave. Some electronic equipment may be damaged by the less expensive modified sine wave output. In many conventional systems, multiple solar panels are connected to a single inverter in a “string inverter” setup. This can limit system efficiency because, when one solar panel is shaded and has reduced power, the overall current provided to the inverter is likewise reduced. String solar inverters are provided in single-phase and three-phase versions.

Microinverters are miniature forms of inverters that can be installed on the back of individual solar panels, providing the option for AC power to be created directly by the panel. For example, LG (Seoul, Korea) produces solar panels with integrated microinverters. Unfortunately, microinverters limit the efficiency of battery charging because the AC power from the panels must be converted back to DC power for battery charging. They also add significant cost to the panels. The additional equipment on the panel may also increase maintenance problems and possibly the risk of lightning strikes. Microinverters generally use maximum power point tracking (MPPT) to optimize power harvesting from the panel or module it is connected to. An example of a microinverter is the Enphase M215 of Enphase Energy (Fremont, Calif.).

The on-grid string solar inverters and microinverters, collectively often simply called solar inverters, provide AC power that can be fed to the grid or directly to a home or office. Alternatively, off-grid inverters (or “battery inverters”) or hybrid inverters can charge batteries. Hybrid inverters can be used to charge batteries with DC current and to provide AC current for the grid or local devices, combining a solar inverter and battery inverter/charger into a single unit. An example of a hybrid inverter is the Conext SW 120/240 VAC hybrid inverter charger 48 VDC (865-4048) by Schneider Electric (Rueil-Malmaison, France) is a 4 kW (4000 watt) pure sine wave inverter or the 2.3 kW Outback Power Hybrid On/Off-grid Solar Inverter Charger 1-Ph 48 VDC by Outback Power (Phoenix, Ariz.).

### Machine Learning and AI

The ECS 20 or central systems in communication with the ECS 20 may employ machine learning, including neural networks and other AI systems, to learn performance profiles for individual power packs 12, including supercapacitors, or entire ESUs 10, or those of a managed fleet of vehicles of collection of devices 16, in order to better estimate and optimize performance including such factors as remaining charge, remaining useful life, times for maintenance, methods for charge control to reduce overheating or to prevent other excursions or safety issues, and strategies to optimize lifetime or power delivery with a given ECS 20. Methods for adaptive learning, neural network analysis, or AI development that can be used with supercapacitor systems or the ESUs 10 described herein include Jean-Noel Marie-Francoise et al., “Supercapacitor modeling with Artificial Neural Network (ANN),” https://www.osti.gov/etdeweb/servlets/purl/20823689, accessed Nov. 1, 2021, which describes an Artificial Neural Network (ANN) using a black box nonlinear multiple inputs single output (MISO) model in which the system inputs are temperature and current, the output is the supercapacitor voltage. See also Elena Danila et al., “Dynamic Modelling of Supercapacitor Using Artificial Neural Network Technique,” International Conference and Exposition on Electrical and Power Engineering, October 2014, DOI: 10.1109/ICEPE.2014.6969988 and https://www.researchgate.net/publication/270888480_Dynamic_Modelling_of_Supercapacitor_Using_Artificial_Neural_Network_Technique, which describes a feed forward artificial neural network structure with two hidden layers and with backpropagation training. Similar systems may be adapted for anticipatory power control as described herein. Also see Akram Eddahech, “Modeling and adaptive control for supercapacitor in automotive applications based on artificial neural networks,” Electric Power Systems Research, vol. 106 (January 2014): 134-141, https://www.sciencedirect.com/science/article/abs/pii/S0378779613002265, which seeks to predict power cycle behavior for supercapacitors using a one-layer feed-forward artificial neural network (ANN). Related publications include U.S. Pub. No. 20190097362, “Configurable Smart Object System with Standard Connectors for Adding Artificial Intelligence to Appliances, Vehicles, and Devices,” published Mar. 28, 2019 by B. Haba et al.; U.S. Pat. No. 9,379,546, “Vector control of grid-connected power electronic converter using artificial neural networks,” issued Jun. 28, 2016 to S. Li et al.; U.S. Pat. No. 7,548,894, “Artificial neural network,” issued Jun. 16, 2009 to Y. Fuji; and U.S. Pub. No. 20160283842, “Neural Network and Method of Neural Network Training United,” issued Sep. 29, 2016 to D. Pescianschi.

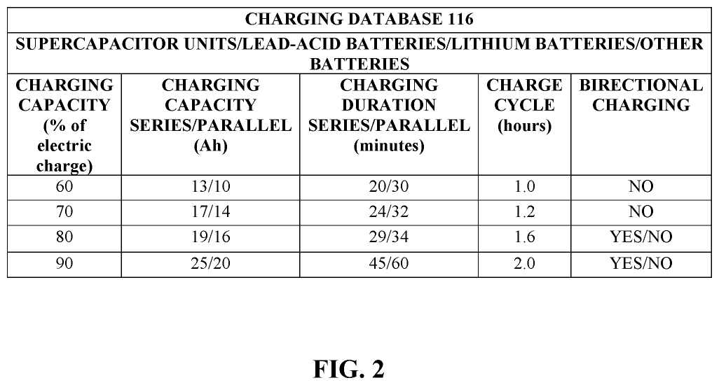

FIG. 1B illustrates a block diagram of a modular multi-type power pack charging apparatus 100, according to one embodiment of the present disclosure. FIG. 1B is described in conjunction with FIG. 2 to FIG. 11 and includes some elements described in FIG. 1A. The modular multi-type power pack charging apparatus 100 may comprise a processor 102, control hardware 104, and charging hardware 106. The processor 102 is a controller that connects all the elements through a control bus (not shown). The processor 102 executes the software or modules in the memory unit 112 and uses data in the charging database 116. The control hardware 104 allows for connections between the batteries to be tested or charged to the charging hardware 106. The charging hardware 106 allows for testing voltages and currents and capacitance, provides various selectable loads for test and discharge, and contains AC and DC current and voltage test meters and chargers. The charging hardware 106 also contains AD and DC charging to various positive and negative levels as well as waveforms over time. The processor 102 may be coupled to the control hardware 104, and the control hardware 104 may be coupled to the charging hardware 106. Further, the charging hardware 106 may be adapted to connect to a plurality of power packs 108. Further, the processor 102 may be configured to control the charging and discharging of the plurality of power packs 108 via the control hardware 104 and the charging hardware 106. The plurality of power packs 108 are the batteries to be tested or charged and may include lead-acid or lithium-based batteries or supercapacitors. Multiple types of batteries may be used together. In the case of a supercapacitor, each battery may contain sub modules. In one embodiment, the modular multi-type power pack charging apparatus 100 may be configured to charge the plurality of power packs 108 of an electric vehicle (not shown). In one embodiment, the electric vehicle may include, but is not limited to, a golf cart, a forklift, a baby cart, an electric car or truck, and an electric bike. Personal transportation devices and other devices may also be used, such as hoverboards, monowheels, Segways®, electric wheelchairs, drones and other aeronautical devices, robotic devices, aquatic devices such as boats or personal watercraft, such as Jet Skis®, etc. In one embodiment, the modular multi-type power pack charging apparatus 100 may be referred to as a system for enhancing the charging capability of the electric vehicle.

Further, the modular multi-type power pack charging apparatus 100 may provide smart energy management to supply electric charge to the vehicle motor from the plurality of power packs 108 in a controlled manner to maximize the efficiency of powering the electric vehicle. Further, the modular multi-type power pack charging apparatus 100 may also provide real-time charging and discharging of the plurality of power packs 108, while the electric vehicle may be continuously accelerating and decelerating along a path. In one embodiment, the modular multi-type power pack charging apparatus 100 may be referred to as a modular graphene power pack for powering the electric vehicle. Furthermore, in one embodiment, the multi-type power pack charging apparatus 100 may be capable of charging, or supplementing the power provided from, chemical and nonchemical batteries, such as, but not limited to, lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, supercapacitor batteries, and combinations or hybrids thereof.

Further, the modular multi-type power pack charging apparatus 100 may comprise a display interface 110 coupled to the processor 102 to continuously display the status of charging and discharging the plurality of power packs 108. The display interface 110 may be used to see the various steps or outputs of each of the modules in the base module 118. The display interface 110 may allow visualization of the charging database 116. The display interface 110 may include a touch input display to allow choices to be made by the user. The display interface 110 may be a display screen or a speaker or both. In one embodiment, the modular multi-type power pack charging apparatus 100 may be integrated within the electric vehicle, maybe be totally external to the electric vehicle or may be divided between the EV and components external to the EV.

In one embodiment, the display interface 110 may include, but is not limited to, a video monitoring display, a smartphone, a tablet, and the like, each of which is capable of displaying a variety of parameters and interactive controls, but could also be as simple as one or more lights indicating charging or discharging status and optionally one or more digital or analog indicators showing remaining useful lifetime, % power remaining, voltage, etc. Further, the display interface may be any state-of-the-art display means without departing from the scope of the disclosure.

Further, the modular multi-type power pack charging apparatus 100 may comprise a memory unit 112 communicatively coupled to the processor 102 via a bus. The memory unit 112 may be configured to receive a set of instructions from the processor 102 while charging and discharging the plurality of power packs 108. In one embodiment, the set of instructions may activate a charging mode or a discharging mode to charge or discharge the plurality of power packs 108. Comm 107 is any type of communications system, such as WiFi, Bluetooth, cellular etc. Comm 107 can be controlled by base module 118 to allow any data inputs and outputs to the network interface 114. The network interface 114 can connect to the internet or cloud to receive or store data to 3^{rd} party networks for use for analysis, reports updates to charging database 116, etc. The network interface 114 may facilitate a communication link among the components of the modular multi-type power pack charging apparatus 100 if the components of multi-type power pack charging apparatus 100 are not all housed in an EV. Furthermore, the network interface 114 may be a wired or a wireless network. The network interface 114, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

Further, the memory unit 112 may be used to store a charging database 116 and a base module 118. The charging database 116 is described with reference to FIG. 2. In one embodiment, the charging database 116 may be configured to store information related to various power packs 108 used while charging and discharging from the modular multi-type power pack charging apparatus 100. In one embodiment, the charging database 116 may be configured to store information related to the power cycle of each of the plurality of power packs 108, the maximum and minimum charge for different types of power packs, and the state of charge (SoC) profile of each of the plurality of power packs 108.

Further, the charging database 116 may be configured to store information related to the management of the plurality of power packs 108. In one embodiment, the information may include, but is not limited to, the type of power pack 108 to be charged, safety specifications, recent performance data, bidirectional charging requirements or history of each of the plurality of power packs 108, etc. In another embodiment, the stored information may also include, but is not limited to, the capacity of each of the plurality of power packs 108, amount of charge required for one trip of the electric vehicle along the path, such as golf course, etc., charging required for a supercapacitor, and acceleration and deceleration data related to the path of the electric vehicle.

In another embodiment, the charging database 116 may provide a detailed report for the electric vehicle's average electric charge consumption over a path. In one embodiment, the charging database 116 may be configured to store information of the consumption of the electric charge per unit per kilometer drive of the electric vehicle from the plurality of power packs 108. For example, if a golf cart is installed with 15 lithium batteries coupled in series, each lithium battery will supply 13 Ampere Hour (Ah) of the electric charge for one hour to drive the golf cart for a distance of one kilometer with an average velocity of 6 m/s.

Further, the modular multi-type power pack charging apparatus 100 may comprise a plurality of modules, as discussed below, to evaluate and enhance the performance of charging and discharging the capacity of the plurality of power packs 108. In one embodiment, the plurality of modules may enhance the performance of the electric vehicle by supplying the electric charge from the plurality of power packs 108 according to the needs of the electric vehicle.

In another embodiment, the charging database 116 may provide specification information for each battery type connected. The specification data may include charging times and amount of charging based upon test charge of the battery type.

In yet another embodiment, the charging database 116 may provide specification information for each battery and sub modules for supercapacitors. The specification data may include charging times and amount of charging based upon test charge of the battery subcomponents. The charging database 116 may provide the waveforms information for each battery and sub modules for supercapacitors as well as the charging waveforms for each battery and sub modules for supercapacitors.

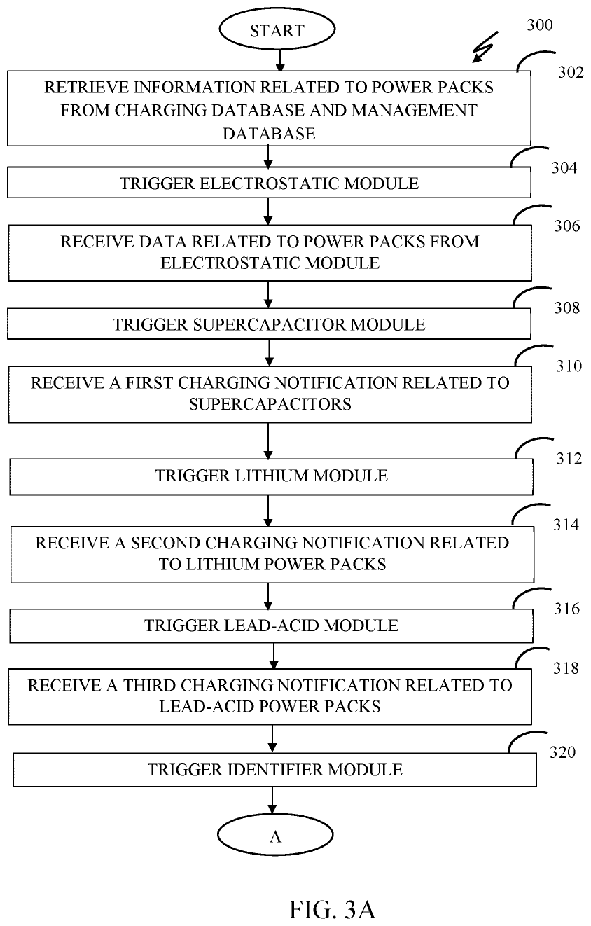

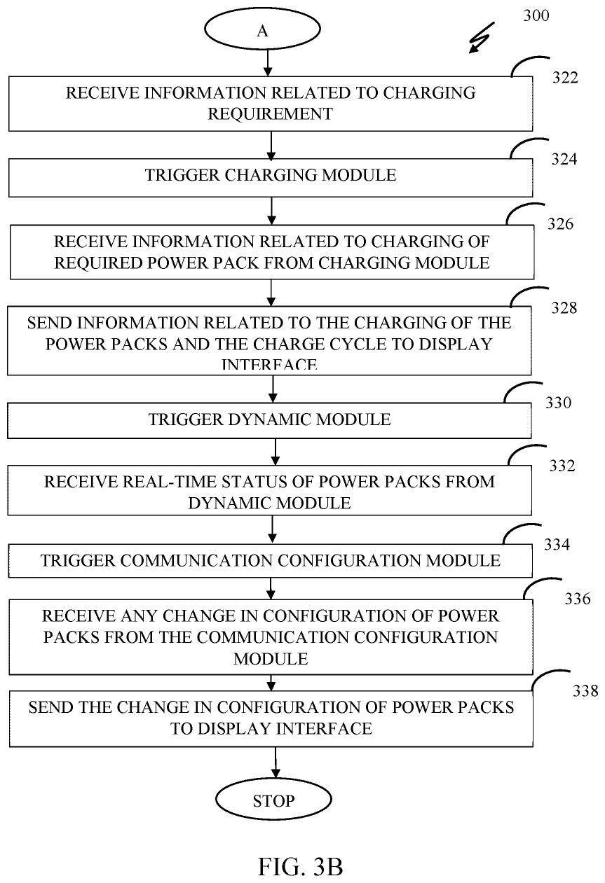

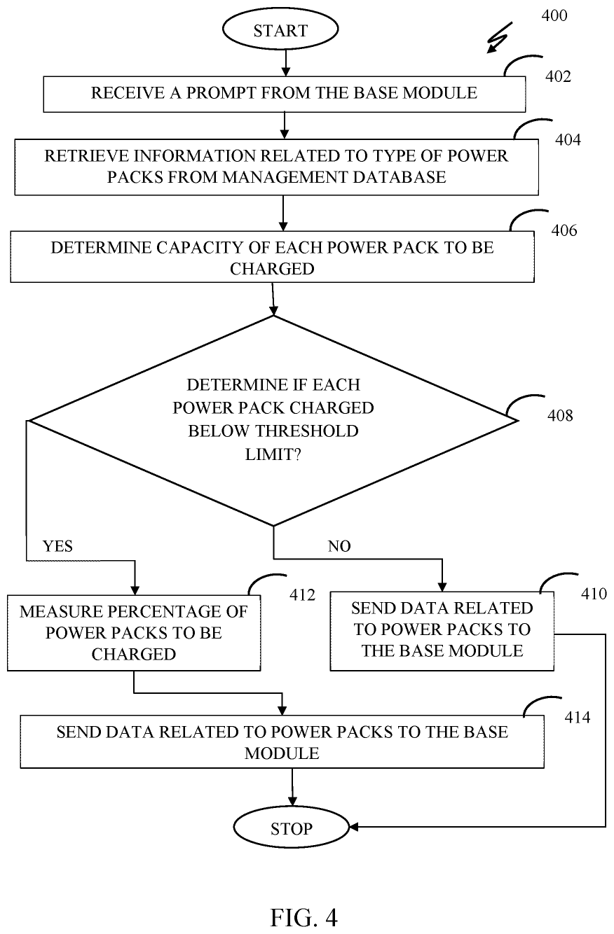

The modular multi-type power pack charging apparatus 100 may comprise or be operatively associated with a base module 118 of memory unit 112 communicatively coupled (via a bus) with the processor 102. In one embodiment, the base module 118 may be configured to manage parameters related to the plurality of power packs 108, such as, but not limited to, electric charge of the plurality of power packs 108 and the performance of the plurality of power packs 108 when installed in the electric vehicle. Further, the base module 118 may be described in FIGS. 3A-3B. In one embodiment, the base module 118 may act as a central hub to receive and send instructions to each of the plurality of modules. In another embodiment, the base module 118 may be configured to activate or deactivate a plurality of sub-modules according to the information received from the processor 102. The base module 118 may be in communication with the network interface 114. Further, the base module 118 may comprise an electrostatic module 120 to determine data related to a type of power packs. In one embodiment, the electrostatic module 120 may be configured to determine the percentage of electric charge available in each of the plurality of power packs 108. The electrostatic module 120 is described in greater detail with respect to FIG. 4.

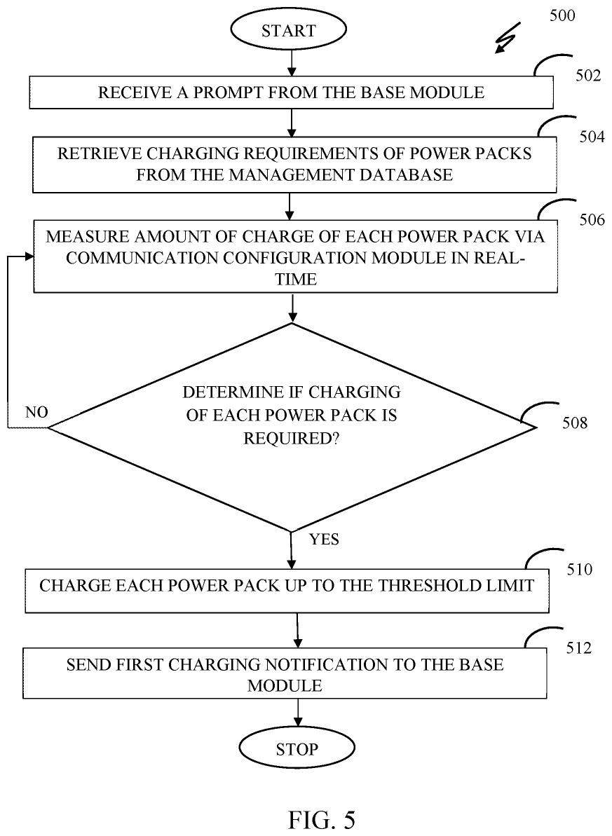

Further, the base module 118 may comprise a supercapacitor module 122 to evaluate and charge the plurality of power packs 108 according to the percentage of electric charge available in each of the plurality of power packs 108 determined by the electrostatic module 120. The supercapacitor module 122 may evaluate all the supercapacitor sub components and individually charge, based upon the specification in the charging database 116, the sub components of a supercapacitor battery type. In one embodiment, the base module 118 may be configured to receive an input request from the electrostatic module 120 related to the requirement of the electric charge of the plurality of power packs 108. The supercapacitor module 122 may be activated and deactivated automatically by the base module 118 according to the input request from the electrostatic module 120. In one embodiment, the supercapacitor module 122 may be configured to retrieve data related to each of the plurality of power packs 108 from the charging database 116. The data related to each of the plurality of the power packs 108 may include an amount of electric charge stored in each of the plurality of power packs 108. In another embodiment, the supercapacitor module 122 may be configured to measure the amount of the electric charge of each of the plurality of power packs 108 with respect to the data retrieved from the charging database 116. Further, the supercapacitor module 122 may determine whether charging of individual supercapacitors or of the entire plurality of power packs 108 is needed. The supercapacitor module 122 is described in greater detail with reference to FIG. 5.

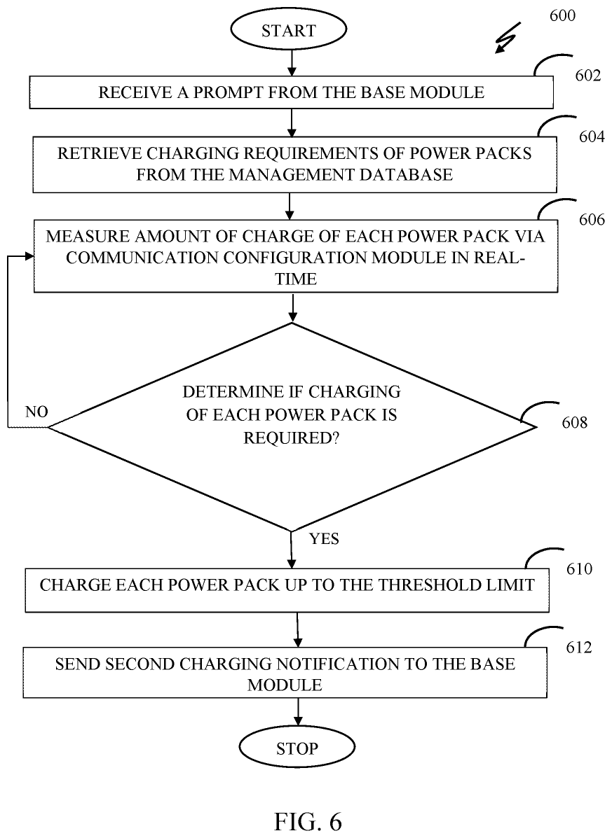

Further, the base module 118 may comprise a lithium module 124 to evaluate and charge the plurality of power packs 108 according to the percentage of electric charge available in each of the plurality of power packs 108 determined by the electrostatic module 120. In one embodiment, the lithium module 124 may function similarly to the supercapacitor module 122. Further, the lithium module 124 may be configured to charge or discharge the plurality of power packs 108 containing lithium batteries. The lithium module 124 is described in greater detail with respect to FIG. 6.

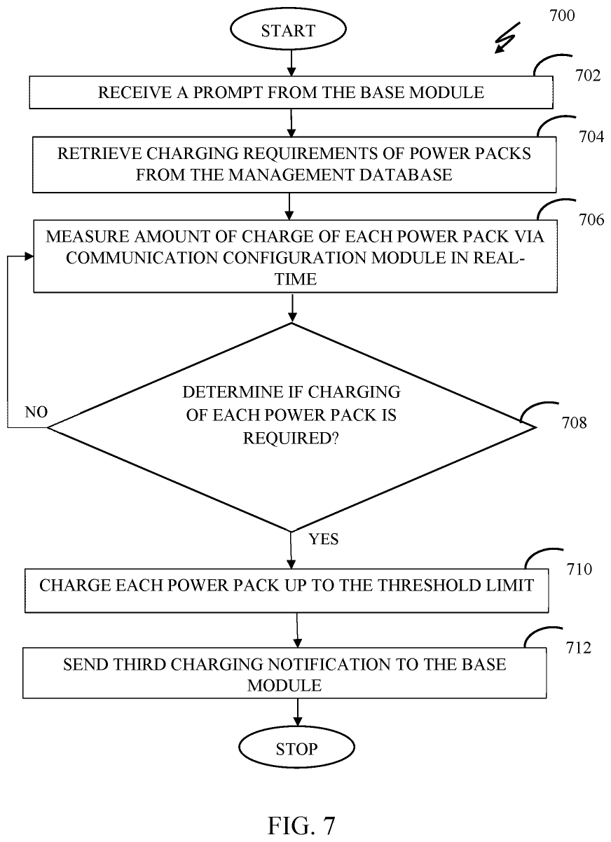

Further, the base module 118 may comprise a lead-acid module 126 to evaluate and charge the plurality of power packs 108 according to the percentage of electric charge available in each of the plurality of power packs 108 determined by the electrostatic module 120. In one embodiment, the lead-acid module 126 may function similarly as the supercapacitor module 122 or the lithium module 124. Further, the lead-acid module 126 may be configured to charge or discharge the plurality of power packs 108 including lead-acid batteries. The lead-acid module 126 is described in greater detail with respect to FIG. 7.

Further, the base module 118 may comprise an other module 128 to evaluate and charge the plurality of power packs 108. For example, in one embodiment, the other module 128 may be configured to charge or discharge the plurality of power packs 108 when the electrostatic module 120 determines that the power packs to be charged or discharged are not suitable for the supercapacitor module 122, the lithium module 124, or the lead-acid module 126.

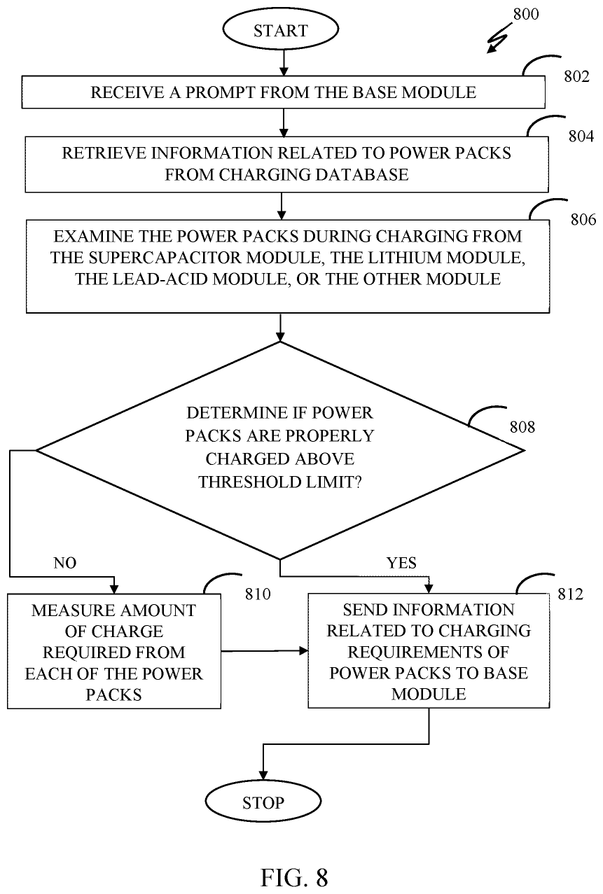

The base module 118 may further comprise an identifier module 130 configured to identify charging requirements of the plurality of power packs 108. For example, in one embodiment, the identifier module 130 may retrieve information from the charging database 116 to evaluate the charge requirement of each of the plurality of power packs 108 when connected for charging or discharging to the modular multi-type power pack charging apparatus 100. The identifier module 130 is described in greater detail with respect to FIG. 8.

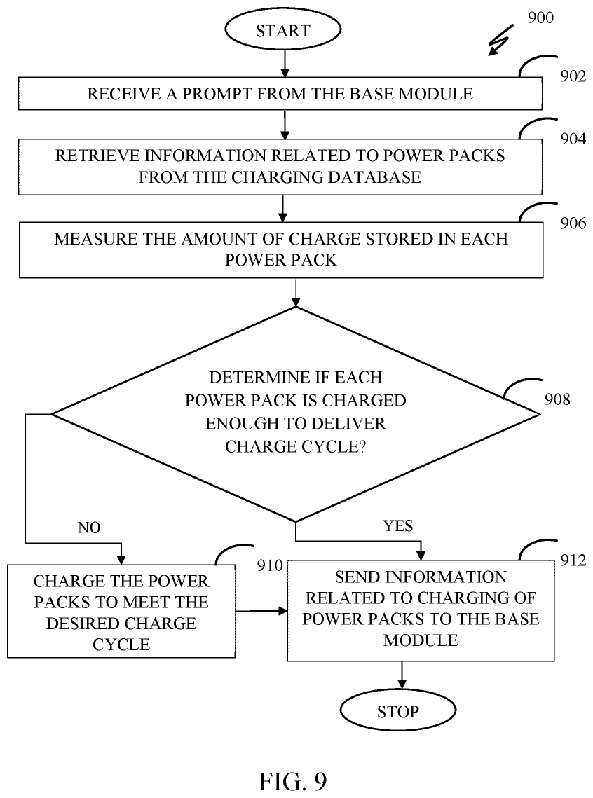

Further, the base module 118 may comprise a charging module 132, communicatively coupled to the electrostatic module 120, the supercapacitor module 122, the lithium module 124, the lead-acid module 126, the other module 128, and the identifier module 130. Further, the charging module 132 may be configured to charge or discharge each of the plurality of power packs 108 up to a threshold limit. For example, in one embodiment, the threshold limit may be more than 90 percent capacity of each of the plurality of power packs 108. The charging module 132 is described in greater detail with respect to FIG. 9.

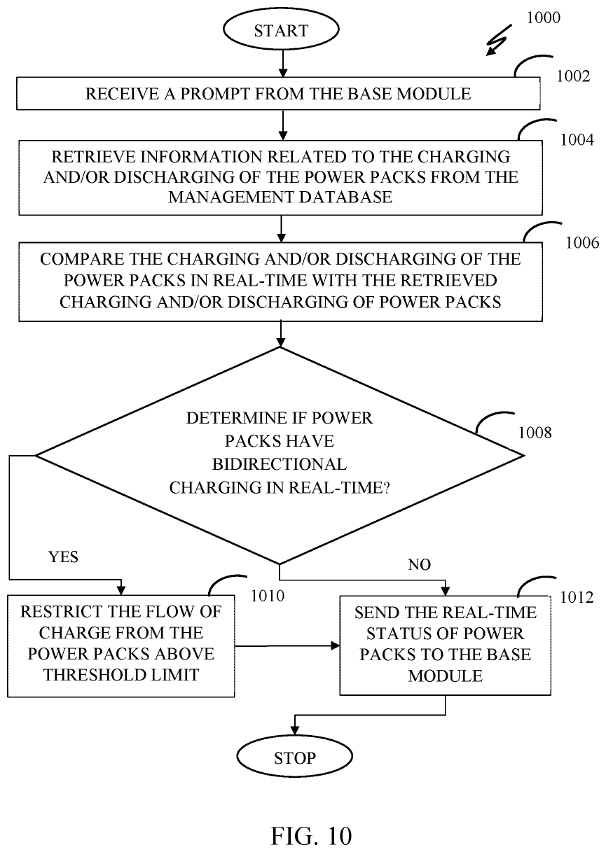

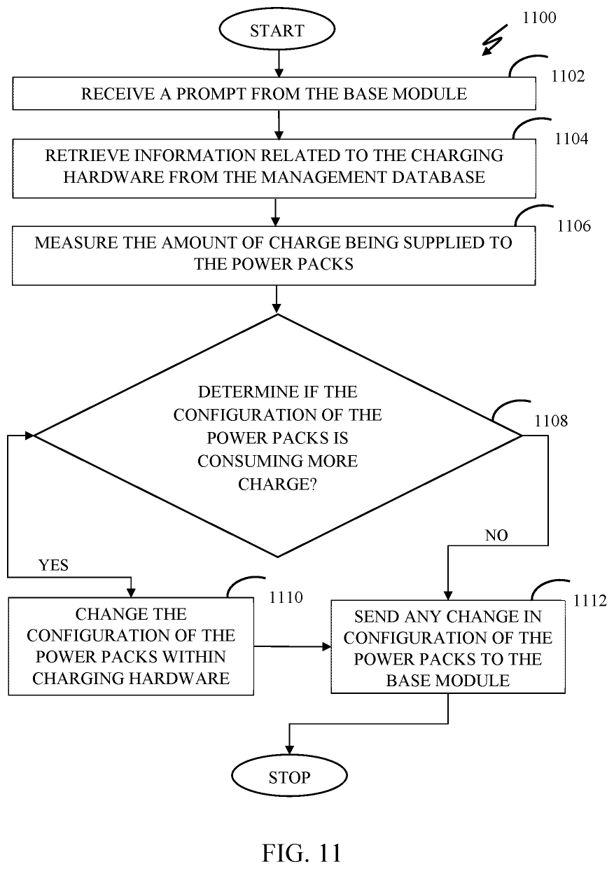

Further, the base module 118 may comprise a dynamic module 134, communicatively coupled to the charging module 132. The dynamic module 134 may be configured to determine the charging and discharging status of the plurality of power packs in real-time. For example, in one embodiment, the dynamic module 134 may evaluate the bidirectional nature of the charge/discharge in real-time in which the electric charge may flow from the modular multi-type power pack charging apparatus 100 into the plurality of power packs 108 or vice versa. The dynamic module 134 is described in greater detail with respect to FIG. 10. Further, the base module 118 may comprise a communication configuration module 136 configured to determine any change in configuration of charged power packs 108 from the charging module 132. For example, in one embodiment, the communication configuration module 136 may be provided to change the configuration of the plurality of power packs 108, such as from series to parallel or vice versa. The communication configuration module 136 is described in greater detail with respect to FIG. 11. It should be noted that a change of configuration is needed to test the batteries in many configurations or to charge the batteries more efficiently, but after the test or charge, the batteries are left as they were originally connected into the EV.

FIG. 2 illustrates the charging database 116 according to an embodiment of the present disclosure. The charging database 116 may be configured to store information related to various power packs 108 used while charging and discharging from the modular multi-type power pack charging apparatus 100. In one embodiment, the charging database 116 stores information of different varieties of power packs, such as, but not limited to, supercapacitor units, lead-acid cells or batteries, lithium batteries, or other types of chemical and nonchemical power packs, including all those mentioned herein. Further, the charging database 116 may be configured to store information related to the power cycle of each of the plurality of power packs 108, the maximum and minimum charge for different types of power packs 108, and the state of charge (SoC) profile of each of the plurality of power packs 108. For example, a supercapacitor unit coupled to a golf cart may have charge cycle of 1 hour with a charging capacity of 60 percent, storing 13 Ah of the electric charge, and the supercapacitor unit, when charged to 60 percent of its capacity, delivers the electric charge for 15 minutes.

In one embodiment, the charging database 116 may be configured to store the charging capacity of each of the plurality of power packs 108 when connected in series or parallel. In another embodiment, the charging database 116 may also store the charging duration of each of the plurality of power packs 108 when connected in series or parallel. In one example, if ten supercapacitor units are connected in series, and each supercapacitor unit receives 13 Ah of the electric charge to reach 60 percent of their capacity for 20 minutes, then each of the ten supercapacitor units may deliver a charge cycle of one hour. Similarly, in another example, ten supercapacitor units are connected in parallel, and each supercapacitor unit receives 10 Ah of the electric charge to reach 60 percent of their capacity for 30 minutes, and each supercapacitor unit can deliver the same charge cycle of one hour. In another example, ten supercapacitor units are connected in series or parallel, and each supercapacitor unit receives 17 Ah to reach 70 percent of its capacity for 24 minutes in series connection and 14 Ah to reach 70 percent of its capacity for 32 minutes in parallel connection, to deliver the charge cycle of 1.2 hours. Similarly, in the case of the ten supercapacitor units connected in series or parallel and charged 80 percent of their capacity, each supercapacitor unit receives 19 Ah of the electric charge within 29 minutes in series connection, and each supercapacitor unit receives 16 Ah of the electric charge within 34 minutes in parallel connection, and each supercapacitor unit delivers 1.6 hours of the charge cycle.

Further, the charging database 116 may be configured to store information regarding different types of power packs 108, such as supercapacitor units, lead-acid batteries, lithium batteries, etc. In one embodiment, the charging database 116 may also store information related to the bidirectional nature of charging or discharging of each of the plurality of power packs 108. In one example, if a supercapacitor unit is charged more than 90 percent of its capacity, the electric charge flowing into the supercapacitor unit reverses its direction to flow back. In another example, if a lithium battery is charged more than 80 percent of its capacity, the electric charge flowing into the lithium battery reverses its direction to flow back. In another example, if a lead-acid battery is charged more than 90 percent of its capacity, the electric charge flowing into the lead-acid battery reverses its direction to flow back.

In one embodiment, the charging database 116, may contain various sub databases, such as, without limitation, a distribution database, a relational database, an object-oriented database, a cloud database, a centralized database, an end user database, a NOSQL database, a commercial database, a personal database and/or an operational database.

FIGS. 3A-3B illustrate a flowchart showing a method 300 performed by the base module 118, according to an embodiment. FIGS. 3A-3B are described in conjunction with FIGS. 1A-1B, FIG. 2, FIG. 4, FIG. 5, FIG. 6, FIG. 7, FIG. 8, FIG. 9, FIG. 10, and FIG. 11. In one embodiment, the base module 118 may be configured to initiate each of plurality of modules to enhance the performance and the capability of the plurality of power packs 108. It should also be noted that in some alternative implementations, the functions noted in the blocks may occur out of the order noted in the drawings. For example, two blocks shown in succession in FIG. 3A and FIG. 3B may be executed substantially concurrently, or the blocks may sometimes be executed in the reverse order, depending upon the functionality involved. In addition, the process descriptions or blocks in flow charts should be understood as representing decisions made by a hardware structure such as a state machine.

Initially, the base module 118 may be configured to retrieve information related to the plurality of power packs 108 from the charging database 116, at step 302. In one embodiment, the information related to each of the plurality of power packs 108 may be the type of power packs 108 connected to the modular multi-type power pack charging apparatus 100, duty cycle or charge cycle of each power pack 108, and/or the capacity of each power pack 108 to store the electric charge. For example, the base module 118 retrieves information from the charging database 116 that the power pack 108 connected for charging is a lead-acid battery coupled to a golf cart, and the charging database 116 states that the charge cycle of the lead-acid battery is 08 for 4 hours, and the lead-acid battery, when charged to its maximum capacity, delivers the electric charge for 30 minutes. Further, the base module 118 may trigger the electrostatic module 120 at step 304.

The electrostatic module 120 is described in greater detail with respect to FIG. 4. FIG. 4 illustrates a flowchart of a method 400 performed by the electrostatic module 120. It should also be noted that in some alternative implementations, the functions noted in the blocks may occur out of the order noted in the drawings. For example, two blocks shown in succession in FIG. 4 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the electrostatic module 120 may receive a prompt from the base module 118 at step 402. In one embodiment, the electrostatic module 120 may be configured to identify the power pack type and the capacity of each power pack 108 connected to the modular multi-type power pack charging apparatus 100. Further, the electrostatic module 120 may be configured to retrieve information related to the type of power packs 108 from the charging database 116, at step 404. For example, the electrostatic module 120 retrieves information from the charging database 116 that the plurality of power packs 108 connected to the modular multi-type power pack charging apparatus 100 are ten supercapacitor units, and these ten supercapacitor units are connected in series. Successively, the electrostatic module 120 may determine the capacity of each power pack 108 to be charged at step 406. In one embodiment, the electrostatic module 120 may determine the capacity of each power pack 108 when connected to the modular multi-type power pack charging apparatus 100. For example, the electrostatic module 120 determines that each of the ten supercapacitor units connected in series can store 20Ah of the electric charge.

In some embodiments, the electrostatic module 120 may test the power packs 108 to find out the type of batteries in the power packs 108, how many batteries there are in the power packs 108, what capability the batteries have in the power packs 108, the state of charge of the batteries in the power packs 108, and, for supercapacitor type batteries, the number of sub modules in the power packs 108. This information is stored in the charging database 116.

Further, the electrostatic module 120 may be configured to determine if each power pack 108 charged below the threshold limit at step 408. For example, in one embodiment, the electrostatic module 120 may check whether each of the plurality of power packs 108 may have the capacity below the threshold limit. In one case, the electrostatic module 120 determines when the supercapacitor units are not charged below the threshold limit; then, the electrostatic module 120 may proceed further to step 410 to send data related to the supercapacitor units to the base module 118. For example, the electrostatic module 120 determines that, when the ten supercapacitor units are charged up to the threshold limit of 90 percent of the electric charge, they do not need to be charged. In another case, the electrostatic module 120 determines that, when the supercapacitor units are charged below the threshold limit, the electrostatic module 120 may proceed further to step 412 to measure the percentage of supercapacitor units to be charged. For example, the electrostatic module 120 determines that the five supercapacitor units charged up to 60 percent of the capacity need to be charged. Further, the electrostatic module 120 may be configured to measure the percentage of power packs to be charged at step 412. For example, the electrostatic module 120 measures that, out of 10 supercapacitor units, five supercapacitor units are charged below 60 percent and need to be charged up to the threshold limit of 90 percent. Successively, the electrostatic module 120 may be configured to send data related to power packs to the base module 118, at step 414. For example, the electrostatic module 120 sends to the base module 118 that, out of ten supercapacitor units, five supercapacitor units are charged below 60 percent and need to be charged up to the threshold limit of 90 percent.

The base module 118 may be configured to receive the data related to the power packs from the electrostatic module 120 at step 306. For example, the base module 118 receives the data that five supercapacitor units are charged below 60 percent and need to be charged up to the threshold limit of 90 percent and five supercapacitor units are charged up to the threshold limit of 90 percent of their capacity and therefore does not need charging. Successively, the base module 118 may be configured to trigger the supercapacitor module 122 at step 308. The supercapacitor module 122 is described in greater detail with respect to FIG. 5.

FIG. 5 illustrates a flowchart of a method 500 performed by the supercapacitor module 122. It should also be noted that in some alternative implementations, the functions noted in the blocks may occur out of the order noted in the drawings. For example, two blocks shown in succession in FIG. 5 may be executed substantially concurrently, or the blocks may sometimes be executed in the reverse order, depending upon the functionality involved. In addition, the process descriptions or blocks in flow charts should be understood as representing decisions made by a hardware structure such as a state machine.

Initially, the supercapacitor module 122 may be configured to receive a prompt from the base module 118, at step 502. The supercapacitor module 122 may be configured to charge each plurality of power packs 108 up to the threshold limit. In one embodiment, the plurality of power packs 108 may be supercapacitor units, and the threshold limit of each supercapacitor unit may be 90 percent of its capacity. In one embodiment, the supercapacitor module 122 may be activated and deactivated automatically by the base module 118 upon receiving a request from the electrostatic module 120 related to the charging requirement of the plurality of power packs 108. Further, the supercapacitor module 122 may be configured to retrieve the charging requirement of the plurality of power packs 108 from the charging database 116, at step 504. In one embodiment, the supercapacitor module 122 may be configured to retrieve the charging requirement of the plurality of power packs 108 to be used or consumed by the electric vehicle, such as golf cart, baby cart, electric car, etc., from the charging database 116. For example, the supercapacitor module 122 retrieves the charging requirement that ten supercapacitor units connected in series need to be charged up to the threshold limit of 90 percent of their capacity.

Further, the supercapacitor module 122 may be configured to measure the amount of electric charge of each of the plurality of power packs 108 via the communication configuration module 136 in real-time, at step 506. In one embodiment, the supercapacitor module 122 may also determine the amount of charge left within each of the plurality of power packs 108 when connected with the modular multi-type power pack charging apparatus 100. In one embodiment, the supercapacitor module 122, using the communication configuration module 136, measures the charge left on each of the plurality of power packs 108. For example, the supercapacitor module 122 measures the amount of the electric charge of the ten supercapacitor units when connected to the modular multi-type power pack charging apparatus; for instance, three supercapacitor units are fully drained, four supercapacitor units are still charged up to 60 percent, and three supercapacitor units are charged more than 90 percent of their capacity. Successively, the supercapacitor module 122 may determine if charging each of the plurality of power packs 108 is required at step 508. For example, the supercapacitor module 122 determines that three supercapacitor units need to be recharged from zero percent of their capacity, and four supercapacitor units need to be recharged from 60 percent of their capacity. The rest of the three supercapacitor units are charged above the threshold limit of 90 percent.

In one case, the supercapacitor module 122 may determine that charging of each of the plurality of power packs 108 is not required, then the supercapacitor module 122 is redirected back to step 506 to measure the amount of electric charge of each power pack. For example, the supercapacitor module 122 determines if each of the ten supercapacitor units is charged up to the threshold limit of 90 percent of their capacity. In another case, the supercapacitor module 122 may determine that charging the plurality of power packs 108 is required; then, the supercapacitor module 122 may move to step 510. For example, the supercapacitor module 122 determines that, if each of the ten supercapacitor units is completely drained to zero percent of their capacity, then the supercapacitor module 122 proceeds to charge each power pack up to the threshold limit, at step 510. In one embodiment, the threshold limit of the power packs 108 may vary according to the desired usage of the power packs 108. For example, in one exemplary embodiment, the threshold limit of each of ten supercapacitor units may be up to 90 percent of their capacity to hold the electric charge of 25 Ah or 20 Ah for series or parallel connection. For example, the supercapacitor module 122 charges the three supercapacitor units initially at zero percent of their capacity to 90 percent of their capacity.

Successively, the supercapacitor module 122 may be configured to send a first charging notification to the base module 118 at step 512. For example, the supercapacitor module 122 sends the first charging notification that out of ten supercapacitor units, three have been charged to the threshold limit of 90 percent. Four supercapacitor units are charged to 90 percent from 60 percent, and the rest of the three supercapacitor units are not charged. Further, the base module 118 may be configured to receive the first charging notification from the supercapacitor module 122 at step 310. For example, the base module 118 receives the first charging notification that, out of ten supercapacitor units, three have been charged to the threshold limit of 90 percent from initially with zero percent of the electric charge, four supercapacitor units are charged to 90 percent from 60 percent, and the rest of three supercapacitor units are not charged.

Successively, the supercapacitor module 122 may be configured to send a first charging notification to the base module 118 at step 512. For example, the supercapacitor module 122 sends the first charging notification that, out of ten supercapacitor units each with 5 sub modules, one supercapacitor unit has three sub modules have been charged to the threshold limit of 90 percent. A second supercapacitor units with all its five sub modules are charged to 90 percent from 60 percent, and the rest of the supercapacitor units are not charged. Further, the base module 118 may be configured to receive the first charging notification from the supercapacitor module 122 at step 310, where the notifications include each supercapacitor unit's data and each of their sub modules data.

Successively, the base module 118 may be configured to trigger the lithium module 124 at step 312. For example, in one embodiment, the lithium module 124 may determine whether there may be lithium batteries to charge or discharge. The lithium module 124 is described in greater detail with respect to FIG. 6.

FIG. 6 illustrates a flowchart of a method 600 performed by the lithium module 124. It should also be noted that in some alternative implementations, the functions noted in the blocks may occur out of the order noted in the drawings. For example, two blocks shown in succession in FIG. 6 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the lithium module 124 may be configured to receive a prompt from the base module 118 at step 602. The lithium module 124 may be configured to charge the plurality of power packs 108 up to the threshold limit. In one embodiment, the plurality of power packs 108 may be lithium batteries, and each lithium battery's threshold limit may be 90 percent of its capacity. In one embodiment, the lithium module 124 may be activated and deactivated automatically by the base module 118 upon receiving the request from the electrostatic module 120 related to the charging requirement of the plurality of power packs 108. Further, the lithium module 124 may be configured to retrieve the charging requirement of the plurality of power packs 108 from the charging database 116, at step 604. In one embodiment, the lithium module 124 may be configured to retrieve the charging requirement of the plurality of power packs 108 to be used or consumed by the electric vehicle, such as golf cart, baby cart, electric car, etc., from the charging database 116. For example, the lithium module 124 may retrieve the charging requirements that 15 lithium batteries connected in series need to be charged equal to more than 90 percent of their capacity.

Further, the lithium module 124 may be configured to measure the amount of electric charge of each of the plurality of power packs 108 via the communication configuration module 136 in real-time, at step 606. In some embodiments where the entire the modular multi-type power pack charging apparatus 100 is integrated into one system, communication is done through an internal bus.

In one embodiment, the lithium module 124 may also measure the charge left within each of the plurality of power packs 108 when connected with the modular multi-type power pack charging apparatus 100. The lithium module 124, using the communication configuration module 136, may measure the amount of charge left on each of the plurality of power packs 108. For example, the lithium module 124, using the communication configuration module 136, determines that the fifteen lithium batteries, when connected to the modular multi-type power pack charging apparatus 100, for instance, five lithium batteries are fully drained, four lithium batteries are still charged up to 60 percent, and six lithium batteries are charged more than 90 percent of their capacity. Successively, the lithium module 124 may determine if charging each of the plurality of power packs 108 is required at step 608. For example, the lithium module 124 determines that five lithium batteries need to be recharged from 30 percent of their capacity, four lithium batteries need to be recharged from 60 percent of their capacity, and the remaining six lithium batteries are charged above the threshold limit of 90 percent.

In one case, the lithium module 124 may determine that charging of each of the plurality of power packs 108 is not required, then the lithium module 124 is redirected back to step 606 to measure the amount of electric charge of each power pack 108. For example, lithium module 124 determines if each of the fifteen lithium batteries is charged equal to or more than 90 percent of their capacity. In another case, if the lithium module 124 determines that charging the plurality of power packs 108 is required, then the lithium module 124 may move to step 610. For example, the lithium module 124 may determine that, if each of the fifteen lithium batteries is completely drained to zero percent of their capacity, then the lithium module 124 may proceed to charge each power pack up to the threshold limit at step 610. In one embodiment, the threshold limit of the power packs may vary according to the desired usage of the power packs 108. In one exemplary embodiment, the threshold limit of each of 15 lithium batteries may be up to 90 percent of their capacity to hold the electric charge. For example, the lithium module 124 charges the five lithium batteries, which are at zero percent of their capacity to 90 percent of their capacity for the electric vehicle to complete one run time along a road of one kilometer.

Successively, the lithium module 124 may be configured to send a second charging notification to the base module 118 at step 612. For example, the lithium module 124 is configured to send the second charging notification that out of 15 lithium batteries, five have been charged to the threshold limit of 90 percent, four lithium batteries are charged to 90 percent from 60 percent, and the rest of six lithium batteries are not charged. Further, the base module 118 may be configured to receive the second charging notification from the lithium module 124 at step 314. For example, the base module 118 receives the second charging notification that out of fifteen lithium batteries, five have been charged to the threshold limit of 90 percent from initially with zero percent of the electric charge, four lithium batteries are charged to 90 percent from 60 percent, and the rest of 6 lithium batteries are not charged.

Successively, the base module 118 may be configured to trigger the lead-acid module 126 at step 316. In one embodiment, the lead-acid module 126 may determine whether there may be lead-acid batteries to charge or discharge. The lead-acid module 126 is described in greater detail with respect to FIG. 7.

FIG. 7 illustrates a flowchart of a method 700 performed by the lead-acid module 126. It should also be noted that in some alternative implementations, the functions noted in the blocks may occur out of the order noted in the drawings. For example, two blocks shown in succession in FIG. 7 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the lead-acid module 126 may be configured to receive a prompt from the base module 118, at step 702. The lead-acid module 126 may be configured to charge the plurality of power packs 108 up to the threshold limit. In one embodiment, the plurality of power packs 108 may be lead-acid batteries, and the threshold limit of each lead-acid battery may be 90 percent of its capacity. In one embodiment, the lead-acid module 126 may be activated and deactivated automatically by the base module 118 upon receiving the request from the electrostatic module 120 related to the charging requirement of the plurality of power packs 108. Further, the lead-acid module 126 may be configured to retrieve the charging requirement of the plurality of power packs 108 from the charging database 116, at step 704. In one embodiment, the lead-acid module 126 may be configured to retrieve the charging requirement of the plurality of power packs 108 to be used or consumed by the electric vehicle, such as golf cart, baby cart, electric car, etc., from the charging database 116. For example, the lead-acid module 126 retrieves the charging requirements that ten lead-acid batteries connected in series need to be charged equal to more than 90 percent of their capacity.

Further, the lead-acid module 126 may be configured to measure the electric charge of each of the plurality of power packs 108 via the communication configuration module 136 in real-time, at step 706. In one embodiment, the lead-acid module 126 may also measure the charge left within each of the plurality of power packs 108 when connected with the modular multi-type power pack charging apparatus 100. In another embodiment, the lead-acid module 126, using the communication configuration module 136, measures the amount of charge left on each of the plurality of power packs 108. For example, the lead-acid module 126 measures that the ten lead-acid batteries when connected to the modular multi-type power pack charging apparatus 100, for instance, four lead batteries are fully drained, four lead-acid batteries are still charged up to 60 percent, and two lead-acid batteries are charged more than 90 percent of their capacity. Successively, the lead-acid module 126 may determine if charging each of the plurality of power pack 108 is required at step 708. For example, the lead-acid module 126 determines that four lead-acid batteries need to be recharged from zero percent of their capacity, four lead-acid batteries need to be recharged from 60 percent of their capacity, and the remaining two lead-acid batteries are charged above the threshold limit of 90 percent.

In one case, the lead-acid module 126 may determine that charging of each of the plurality of power packs 108 is not required, then the lead-acid module 126 is redirected back to step 706 to measure the amount of electric charge of each power pack. For example, the lead-acid module 126 determines if each of the ten lead-acid batteries is charged equal to or more than 90 percent of their capacity. In another case, the lead-acid module 126 may determine that charging the plurality of power packs 108 is required; then, the lead-acid module 126 may move to step 710. For example, the lead-acid module 126 determines that if each of the ten lead-acid batteries is completely drained to zero percent of their capacity, then the lead-acid module 126 may charge each power pack up to the threshold limit at step 710. In one embodiment, the threshold limit of the power packs may vary according to the desired usage of the power packs. In one exemplary embodiment, the threshold limit of each of ten lead-acid batteries is up to 90 percent of their capacity to hold the electric charge. For example, the lead-acid module 126 charges the four lead-acid batteries, which are at 30 percent of their capacity to 90 percent of their capacity for the electric vehicle to complete one run time along a road of one kilometer.

Successively, the lead-acid module 126 may be configured to send a third charging notification to the base module 118 at step 712. For example, the lead-acid module 126 is configured to send the third charging notification that out of ten lead-acid batteries, four have been charged to the threshold limit of 90 percent, four lead-acid batteries are charged to 90 percent from 60 percent, and the rest of two lead-acid batteries are not charged. Further, the base module 118 may be configured to receive the third charging notification from the lead-acid module 126 at step 318. For example, the base module 118 receives the third charging notification that out of ten lead-acid batteries, four have been charged to the threshold limit of 90 percent from initially with zero percent of the electric charge, four lead-acid batteries are charged to 90 percent from 60 percent, and the rest of two lead-acid batteries are not charged.

Further, the base module 118 may be configured to trigger identifier module 130 at step 320. In one embodiment, the identifier module 130 may be configured to identify problems while charging the plurality of power packs 108. The identifier module 130 is described in conjunction with FIG. 8. FIG. 8 illustrates a flowchart of a method 800 performed by the identifier module 130. It should also be noted that in some alternative implementations, the functions noted in the blocks may occur out of the order noted in the drawings. For example, two blocks shown in succession in FIG. 8 may be executed substantially concurrently, or the blocks may sometimes be executed in the reverse order, depending upon the functionality involved. In addition, the process descriptions or blocks in flow charts should be understood as representing decisions made by a hardware structure such as a state machine.

At first, the identifier module 130 may be configured to receive a prompt from the base module 118, at step 802. The identifier module 130 may be configured to determine the charge level required from each of the plurality of power packs 108. Further, the identifier module 130 may be configured to retrieve information related to the plurality of power packs 108 from the charging database 116, at step 804. In one embodiment, the identifier module 130 may be configured to retrieve information related to the charging or discharging the plurality of power packs 108. For example, the identifier module 130 retrieves information that the ten lead-acid batteries connected to the modular multi-type power pack charging apparatus 100 have the state of charge profile as, ten lead-acid batteries have a charge cycle of two hours when charged more than 95 percent of their capacity, and the ten lead-acid batteries are charged up to 90 percent from the lead-acid module 126. Further, the identifier module 130 may be configured to examine the plurality of power packs during charging from the supercapacitor module 122, the lithium module 124, the lead-acid module 126, or the other module 128 at step 806. For example, the identifier module 130 performs examination that out of the ten lead-acid batteries, only six lead-acid batteries are charged up to 90 percent of their capacity, and the remaining four lead-acid batteries are not charged above 60 percent of their capacity due to the presence of more acid in the four lead-acid batteries.

Successively, the identifier module 130 may determine if the plurality of power packs 108 are properly charged above the threshold limit at step 808. In one embodiment, the identifier module 130 may be configured to determine whether each of the plurality of power packs 108 may be charged above the threshold limit. In one case, the identifier module 130 may determine if the plurality of power packs 108 are charged below the threshold limit, then the identifier module 130 may proceed to step 810 to measure the amount of the electric charge required from each of the plurality of power packs 108. For example, the identifier module 130 determines that if the required electric charge from the ten lead-acid batteries is 20 hours of the charge cycle and out of the ten lead-acid batteries, six are charged above the threshold limit of 90 percent to deliver the charge cycle of two hours for each lead-acid battery and the remaining four which are charge below 60 percent of their capacity deliver the charge cycle for 1 hour only for each of these four lead-acid batteries. Therefore, identifier module 130 measures that the ten lead-acid batteries with the current state of charge profile can deliver only 16 hours of the charge cycle, and the identifier module 130 may then proceed to step 812, to send the information related to the charging requirements to the base module 118.

In another case, the identifier module 130 may determine that if each of the plurality of power packs 108 are charged above the threshold limit, then the identifier module 130 may proceed to step 812 to send information related to the charging of the plurality of power packs 108 to the base module 118. For example, the identifier module 130 determines that out of 10 lead-acid batteries, each of the ten lead-acid batteries are charged above the threshold limit of 90 percent to maintain the state of charge profile by delivering the continuous charge cycle for 20 hours from the ten lead-acid batteries. Further, the identifier module 130 may be configured to send the information related to the charging requirements of the plurality of power packs 108 to the base module 118, at step 812. For example, the identifier module 130 is configured to send to the base module 118 that out of 10 lead-acid batteries, four batteries need to be charged to achieve an overall charge cycle of 20 hours from the lead-acid batteries. Successively, the base module 118 may be configured to receive information about charging the plurality of power packs 108 at step 322. For example, the base module 118 receives that out of 10 lead-acid batteries, four batteries need to be charged to achieve an overall charge cycle of 20 hours from the lead-acid batteries.

Further, the base module 118 may be configured to trigger the charging module 132 at step 324. Further, the charging module 132 is described in greater detail with respect to FIG. 9. FIG. 9 illustrates a flowchart of a method 900 performed by the charging module 132. It should also be noted that in some alternative implementations, the functions noted in the blocks may occur out of the order noted in the drawings. For example, two blocks shown in succession in FIG. 9 may be executed substantially concurrently, or the blocks may sometimes be executed in the reverse order, depending upon the functionality involved. In addition, the process descriptions or blocks in flow charts should be understood as representing decisions made by a hardware structure.

At first, the charging module 132 may be configured to receive a prompt from the base module 118, at step 902. The charging module 132 may be configured to charge the plurality of power packs 108 (and sub modules for supercapacitors) to meet the desired charge cycle. In one embodiment, the desired charge cycle of each of the plurality of power packs 108 may be 2 hours when each power pack is charged up to the threshold limit of 90 percent. In one embodiment, the charging module 132 may be configured to activate or deactivated by the base module 118 according to the information received from the identifier module 130 to charge or discharge the plurality of power packs 108, respectively. Successively, the charging module 132 may be configured to retrieve information related to the plurality of power packs 108 from the charging database 116, at step 904. In one embodiment, the charging module 132 may retrieve information that each of the plurality of power packs 108 is charged below the threshold limit. For example, the charging module 132 retrieves information that the ten lead-acid batteries are charged nearly 80 percent of their capacity, which is below the threshold limit of 90 percent to deliver the desired charge cycle of 20 hours. For supercapacitors the charging time may be a factor often times shorter.

Further, the charging module 132 may be configured to measure the amount of electric charge stored in each of the plurality of power packs 108, at step 906. In one embodiment, the charging module 132 may be configured to measure the charge stored in each of the plurality of power packs 108 (and sub modules for supercapacitor units), which may be previously charged by their respective modules. For example, charging module 132 measures that out of the ten supercapacitor units, five are charged 70 percent of their capacity, four are charged 75 percent of their capacity, and one is charged above the threshold limit of 90 percent, by the supercapacitor module 122, and out of the 15 lithium batteries five are charged 90 percent of their capacity, six are charged around 60 percent of their capacity, and four are charged 70 percent of their capacity, by the lithium module 124, and similarly, out of the ten lead-acid batteries six are charged 90 percent of their capacity, and four are charged near 60 percent of their capacity, by the lead-acid module 126.

Further, the charging module 132 may determine if each of the plurality of power packs 108 (and sub modules for supercapacitor units), is charged enough to deliver the desired charge cycle at step 908. In one embodiment, the charging module 132 may determine whether each of the plurality of power packs 108 are charged enough for consumption or to be used during the specified or desired charge cycle. In one case, the charging module 132 may determine if the plurality of power packs 108 (and sub modules for supercapacitor units), is not charged equal to or above the threshold limit to deliver the desired charge cycle from each power pack. For example, the charging module 132 determines that if the desired charge cycle from the ten lead-acid batteries is 20 hours and out of the ten lead-acid batteries, six are charged 90 percent of their capacity, and four are charged near 60 percent of their capacity, and the overall charge cycle of the ten lead-acid batteries is 16 hours, which is 4 hours less than the desired charge cycle. In this case, the charging module 132 may proceed to step 910 to charge the plurality of power packs 108 to meet the desired charge cycle. In another case, the charging module 132 may determine if the plurality of power packs 108 is equal to or above the threshold limit to deliver the desired charge cycle. For example, the charging module 132 determines that if the desired charge cycle from the ten lead-acid batteries is 20 hours, and each of the ten lead-acid batteries is charged above the threshold limit of 90 percent to deliver the charge cycle of 20 hours (two hours from each lead-acid battery). In this case, the charging module 132 may proceed to step 912 to send the information related to the plurality of power packs 108.

Successively, the charging module 132 may be configured to charge the plurality of power packs 108 to meet the desired charge cycle at step 910. For example, the charging module 132 charges the ten lead-acid batteries if the desired charge cycle from the ten lead-acid batteries is 20 hours, and out of the ten lead-acid batteries, six are charged 90 percent of their capacity, and four are charged near 60 percent of their capacity, and the overall charge cycle of the ten lead-acid batteries is 16 hours, which is four hours less than the desired charge cycle, then the charging module 132 charges the rest of four lead-acid batteries up to the threshold limit of 90 percent to meet the desired charge cycle of two hours from each of the ten lead-acid batteries. Further, the charging module 132 may be configured to send the information about charging the plurality of power packs 108 to the base module 118, at step 912. For example, the charging module 132 is configured to send to the base module 118 that each of the ten lead-acid batteries is charged above the threshold limit of 90 percent to deliver the desired charging cycle of 20 hours. Successively, the base module 118 receives the information related to charging required power packs from the charging module 132, at step 326. For example, the base module 118 receives that each of the ten lead-acid batteries is charged above the threshold limit of 90 percent to deliver the desired charging cycle of 20 hours.

Further, the base module 118 may be configured to send the information about charging the plurality of power packs 108 and the charge cycle to the display interface 110, at step 328. For example, the base module 118 sends to the display interface 110 that each of the ten lead-acid batteries is charged above the threshold limit of 90 percent to deliver the desired charging cycle of 20 hours. Successively, the base module 118 may be configured to trigger the dynamic module 134 at step 330. Further, the dynamic module 134 is described in greater detail with respect to FIG. 10.

FIG. 10 illustrates a flowchart of a method 1000 performed by the dynamic module 134. It should also be noted that in some alternative implementations, the functions noted in the blocks may occur out of the order noted in the drawings. For example, two blocks shown in succession in FIG. 10 may be executed substantially concurrently, or the blocks may sometimes be executed in the reverse order, depending upon the functionality involved. In addition, the process descriptions or blocks in flow charts should be understood as representing decisions made by a hardware structure.

Initially, the dynamic module 134 may be configured to receive a prompt from the base module 118, at step 1002. The dynamic module 134 may be configured to restrict the flow of the electric charge in real-time towards each of the plurality of power packs 108 when each of the plurality of power packs 108 may be charged above the threshold limit. In one embodiment, the flow of the electric charge may be restricted due to the bidirectional charging of each of the plurality of power packs 108 above the threshold limit. The dynamic module 134 may be configured to be activated or deactivated in real-time after the plurality of power packs 108 have been charged from the charging module 132. Further, the dynamic module 134 may be configured to retrieve information related to the charging or discharging the plurality of power packs 108 from the charging database 116, at step 1004. In one embodiment, the dynamic module 134 may be configured to retrieve information related to the charging or discharging nature of each of the plurality of power packs 108. For example, the dynamic module 134 retrieves information that the ten lead-acid batteries when coupled in series and connected to the modular multi-type power pack charging apparatus 100 for charging up to the threshold limit of 90 percent, and after being charged up to 90 percent of their capacity, the electric charge flows in the reverse direction back into the modular multi-type power pack charging apparatus 100.

Successively, the dynamic module 134 may be configured to compare the charging and discharging of the plurality of power packs 108 in real-time with the retrieved charging and discharging of the plurality of power packs 108, at step 1006. In one embodiment, the dynamic module 134 may be configured to compare in real-time the charging and discharging of each of the plurality of power packs 108 charged from the charging module 132 with the plurality of power packs 108 retrieved. For example, the dynamic module 134 compares that the ten lead-acid batteries when charged above the threshold limit of 90 percent of their capacity, the electric charge flows in the reverse direction back into the modular multi-type power pack charging apparatus 100, and the electric charge flowing into the ten lead-acid batteries when charged in real-time by the charging module 132, does not flow back until the each of the ten lead-acid batteries are charged up to 90 percent of their capacity, irrespective of the configuration of the batteries, such as in series or parallel.

The dynamic module 134 may be configured to determine if the plurality of power packs 108 have bidirectional charging in real-time, at step 1008. In one embodiment, the dynamic module 134 may be configured to determine if each of the plurality of power packs 108 being charged by the charging module 132 may have the bidirectional nature of the charge. In one case, the dynamic module 134 may determine that if the plurality of power packs 108 have bidirectional charging and discharging capability, the dynamic module 134 may proceed further to step 1010 to restrict the flow of the electric charge from the plurality of power packs above the threshold limit. For example, the dynamic module 134 determines that if each of the ten lead-acid batteries, when charged above the 90 percent of capacity, the electric charge flows back into the modular multi-type power pack charging apparatus 100, the dynamic module 134 is configured to restrict the flow of the electric chargeback by detaching the ten lead-acid batteries from the charging mode. The charging mode may be an automatic preprogrammed actuation to start charging of the plurality of power packs 108. In this case, the dynamic module 134 is configured to send the real-time status of the plurality of power packs 108 to the base module 118 at step 1012.

In another case, the dynamic module 134 may determine if the plurality of power packs 108 does not have bidirectional charging and discharging capability, in which case the dynamic module 134 may proceed directly to step 1012 to send the real-time status of the plurality of power packs 108 to the base module 118. For example, the dynamic module 134 determines that if each of the ten lead-acid batteries, when charged above the 90 percent of capacity, the electric charge does not flow back into the modular multi-type power pack charging apparatus 100, the dynamic module 134 is configured to send the real-time status of the ten lead-acid batteries to the base module 118. Successively, the base module 118 may be configured to receive the real-time status of the plurality of power packs 108 from the dynamic module 134, at step 332. For example, the base module 118 receives that each of the ten lead-acid batteries, when charged above the 90 percent of capacity, the electric charge does not flow back into the modular multi-type power pack charging apparatus 100.

Successively, the base module 118 may be configured to trigger the communication configuration module 136 at step 334 (or if the system is integrated using a communication bus). The communication configuration module 136 is described in greater detail with respect to FIG. 11.

FIG. 11 illustrates a flowchart of a method 1100 performed by the communication configuration module 136. It should also be noted that, in some alternative implementations, the functions noted in the blocks may occur out of the order noted in the drawings. For example, two blocks shown in succession in FIG. 11 may be executed substantially concurrently, or the blocks may sometimes be executed in the reverse order, depending upon the functionality involved. In addition, the process descriptions or blocks in flow charts should be understood as representing decisions made by a hardware structure.

At first, the communication configuration module 136 may be configured to receive a prompt from the base module 118, at step 1102. The communication configuration module 136 may be configured to change the configuration of the plurality of power packs 108 when connected to the modular multi-type power pack charging apparatus 100. In one embodiment, the configuration may be series or parallel. In one embodiment, the communication configuration module 136 may be configured to facilitate communication between the base module 118 and the charging hardware 106. Further, the communication configuration module 136 may be configured to retrieve information related to the charging hardware 106 from the charging database 116, at step 1104. In one embodiment, the communication configuration module 136 may be configured to retrieve the coupling of the plurality of power packs 108 within the charging hardware 106 from the charging database 116. In one example, the communication configuration module 136 retrieves that the ten lead-acid batteries are connected in series within the charging hardware 106 to receive the supply of the electric charge, and each of the ten lead-acid batteries is charged up to the threshold limit of 90 percent within 45 minutes of charging. In another example, the communication configuration module 136 retrieves that the ten lead-acid batteries are connected in parallel within the charging hardware 106 to receive the supply of the electric charge, and each of the ten lead-acid batteries is charged up to the threshold limit of 90 percent within 60 minutes of charging.

Successively, the communication configuration module 136 may be configured to measure the amount of charge being supplied to each of the plurality of power packs 108, at step 1106. In one embodiment, the communication configuration module 136 may be configured to measure the electric charge supplied to the plurality of power packs from the charging module 132. For example, the communication configuration module 136 measures that out of the ten lead-acid batteries coupled in series, five lead-acid batteries are charged up to the threshold limit of 90 percent within 45 minutes of charging, rest of the five lead-acid batteries are charged below the threshold limit of 90 percent within these 35 minutes of charging. Further, the communication configuration module 136 may determine if the configuration of the plurality of power packs 108 is consuming more electric charge at step 1108.

In one embodiment, the communication configuration module 136 may be configured to determine that the plurality of power packs 108 consumes more electric charge than desired to charge each of the plurality of power packs 108 up to the threshold limit. In one case, the communication configuration module 136 may be configured to determine that the plurality of power packs 108 may consume more electric charge to reach the threshold limit. For example, the communication configuration module 136 determines that out of the ten lead-acid batteries coupled in series, each battery consumes a 25 Ah charge to reach the threshold limit of 90 percent of their capacity. In this case, the communication configuration module 136 may proceed to step 1110, to change the configuration of the plurality of power packs 108. In another case, the communication configuration module 136 may be configured to determine that the plurality of power packs 108 does not consume more electric charge to reach the threshold limit. For example, the communication configuration module 136 determines that each of the ten lead-acid batteries consumes 20 Ah of the electric charge to reach the desired threshold limit of 90 percent. In this case, the communication configuration module 136 may proceed to step 1112 to send the base module 118 that no change in configuration is required.

Further, the communication configuration module 136 may be configured to change the configuration of the plurality of power packs 108 within the charging hardware 106, at step 1110. In one embodiment, the plurality of power packs 108 may consume more electric charge to reach the threshold limit. For example, the communication configuration module 136 changes the configuration in a manner that out of the ten lead-acid batteries coupled in series, each battery consumes a 25Ah charge to reach the threshold limit of 90 percent of their capacity. In this case, the ten lead-acid batteries are changed to parallel configuration. In this case, the communication configuration module 136, after changing the configuration of the plurality of power packs 108, may be redirected back to step 1108, to determine whether the configuration of the plurality of power packs 108 is consuming more electric charge. Successively, the communication configuration module 136 may be configured to send any change in the configuration of the plurality of power packs 108 to the base module 118, at step 1112. For example, the communication configuration module 136 is configured to send to the base module 118 that the ten lead-acid batteries are consuming 25 Ah of electric charge when coupled in series to reach the threshold limit of 90 percent, and these ten lead-acid batteries when connected in parallel, consume only 20 Ah of the electric charge to reach the threshold limit of 90 percent. Therefore, the communication configuration module 136 may be configured to reduce the consumption of the electric charge while charging the plurality of power packs 108.

Successively, the base module 118 may be configured to receive any change in configuration of the plurality of power packs 108, at step 336. For example, the base module 118 receives that the ten lead-acid batteries are consuming 25 Ah of electric charge when coupled in series to reach the threshold limit of 90 percent, and these ten lead-acid batteries, when connected in parallel, consume only 20 Ah of the electric charge to reach the threshold limit of 90 percent. Further, the base module 118 may be configured to send the change in configuration of the plurality of power packs 108 to the display interface 110, at step 338. For example, the display interface 110 display, the ten lead-acid batteries are consuming 25 Ah of electric charge when coupled in series to reach the threshold limit of 90 percent, and these ten lead-acid batteries, when connected in parallel, consume only 20 Ah of the electric charge to reach the threshold limit of 90 percent.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

1. A modular multi-type power pack charging apparatus, comprising:
a plurality of power packs comprising at least two different types of power packs connected in series and/or in parallel;
a processor communicatively coupled to the plurality of power packs to control charging and discharging of the plurality of power packs;
a memory unit communicatively coupled to the processor, the memory unit comprising:
a charging database to store information related to each type of power pack of the plurality of power packs; and
a plurality of energy source modules to control charging and discharging of a respective type of power pack according to instructions received from the processor; and
a display interface coupled to the processor and configured to continuously display a status of charging and discharging of the plurality of power packs.

2. The apparatus of claim 1, wherein the at least two different types of power packs are selected from the group consisting of lithium, supercapacitor, and lead-acid.

3. The apparatus of claim 2, wherein the plurality of power packs comprises a lithium power pack and a supercapacitor power pack.

4. The apparatus of claim 2, wherein the plurality of power packs comprises a lithium power pack and a lead-acid power pack.

5. The apparatus of claim 1, wherein the memory unit further comprises an electrostatic module to:
determine the type of each power pack of the plurality of power packs;
receive information related to the determined type of each power pack of the plurality of power packs from the charging database;
determine a capacity of each power pack of the plurality of power packs from the received information;
determine a charging state of each power pack of the plurality of power packs;
determine that a first power pack of the plurality of power packs is charged below a first threshold limit based on the information retrieved from the charging database; and
in response to determining that the first power pack of the plurality of power packs is charged below the first threshold limit, instruct an energy source module corresponding to the type of the first power pack to charge the first power pack to the first threshold limit.

6. The apparatus of claim 5, wherein the electrostatic module is further to:
determine that a second power pack of the plurality of power packs is charged below a second threshold limit; and
in response to determining that the second power pack of the plurality of power packs is charged below the second threshold limit, instruct an energy source module corresponding to the type of the second power pack to charge the second power pack to the second threshold limit.

7. The apparatus of claim 1, wherein the memory unit further comprises a dynamic module to:
determine whether a first power pack has a bidirectional charging capability; and
in response to determining that the first power pack has a bidirectional charging capability:
determine, while a first power pack is being charged, that electricity is flowing in a reverse direction from the first power pack to charging hardware for the first power pack; and
in response to determining, while the first power pack is being charged, that electricity is flowing in a reverse direction from the first power pack to the charging hardware, restricting electrical flow from the charging hardware to the first power pack.

8. The apparatus of claim 7, wherein the dynamic module is further to:
in response to determining that the first power pack does not have a bidirectional charging capability, report a real-time charging status of the first power pack.

9. The apparatus of claim 1, wherein the memory unit comprises an identifier module to:
identify charging and/or discharging requirements for each power pack of the plurality of power packs in order to meet power supply requirements of a particular device to be powered.

10. The apparatus of claim 9, wherein identifying comprises:
accessing information about the particular device to be powered;
accessing information about each power pack of the plurality of power packs from the charging database;
measuring an amount of charge stored in each power pack of the plurality of power packs;
determining if each power pack of the plurality of power packs has enough charge to meet the power supply requirements of the particular device; and
in response to determining that a first power pack of the plurality of power packs does not have enough charge to meet the power supply requirements of the particular device, charging the first power pack to a level to meet the power supply requirements of the particular device.

11. A method comprising:
providing a plurality of power packs comprising at least two different types of power packs connected in series and/or in parallel;
communicatively coupling a processor to the plurality of power packs to control charging and discharging of the plurality of power packs;
communicatively coupling a memory unit to the processor, the memory unit comprising:
a charging database to store information related to each type of power pack of the plurality of power packs; and
a plurality of energy source modules, each energy source module corresponding to a respective type of power pack;
controlling charging and discharging of the plurality of power packs using the plurality of energy source modules according to instructions from the processor; and
continuously displaying a status of charging and discharging of the plurality of power packs on a display interface.

12. The method of claim 11, wherein the at least two different types of power packs are selected from the group consisting of lithium, supercapacitor, and lead-acid.

13. The method of claim 12, wherein the plurality of power packs comprises a lithium power pack and a supercapacitor power pack.

14. The method of claim 12, wherein the plurality of power packs comprises a lithium power pack and a lead-acid power pack.

15. The method of claim 11, wherein controlling comprises:
determining the type of each power pack of the plurality of power packs;
receiving information related to the determined type of each power pack of the plurality of power packs from the charging database;
determining a capacity of each power pack of the plurality of power packs from the received information;
determining a charging state of each power pack of the plurality of power packs;
determining that a first power pack of the plurality of power packs is charged below a first threshold limit based on the information retrieved from the charging database; and
in response to determining that the first power pack of the plurality of power packs is charged below the first threshold limit, instructing an energy source module corresponding to the type of the first power pack to charge the first power pack to the first threshold limit.

16. The method of claim 15, wherein controlling further comprises:
determine that a second power pack of the plurality of power packs is charged below a second threshold limit; and
in response to determining that the second power pack of the plurality of power packs is charged below the second threshold limit, instructing an energy source module corresponding to the type of second power pack to charge the second power pack to the second threshold limit.

17. The method of claim 11, wherein controlling comprises:
determining whether a first power pack has a bidirectional charging capability; and in response to determining that the first power pack has a bidirectional charging capability:
determining, while a first power pack is being charged, that electricity is flowing in a reverse direction from the first power pack to charging hardware for the first power pack; and
in response to determining, while the first power pack is being charged, that electricity is flowing in a reverse direction from the first power pack to the charging hardware, restricting electrical flow from the charging hardware to the first power pack.

18. The method of claim 17, wherein controlling further comprises:
in response to determining that the first power pack does not have a bidirectional charging capability, reporting a real-time charging status of the first power pack.

19. The method of claim 11, wherein controlling further comprises:
identifying charging and/or discharging requirements for each power pack of the plurality of power packs in order to meet power supply requirements of a particular device to be powered.

20. The method of claim 19, wherein controlling further comprises:
accessing information about the particular device to be powered;
accessing information about each power pack of the plurality of power packs from the charging database;
measuring an amount of charge stored in each power pack of the plurality of power packs;
determining if each power pack of the plurality of power packs has enough charge to meet the power supply requirements of the particular device; and
in response to determining that a first power pack of the plurality of power packs does not have enough charge to meet the power supply requirements of the particular device, charging the first power pack to a level to meet the power supply requirements of the particular device.
